(19) United States
(12) Patent Application Publication
(10) Pub. No.: US 2023/0317920 A1
(43) Pub. Date: Oct. 5, 2023

(54) PRODUCTION METHOD FOR SULFIDE SOLID ELECTROLYTE

(71) Applicant: IDEMITSU KOSAN CO., LTD, Tokyo (JP)

(72) Inventors: Yusuke ISEKI, Chiba-shi (JP); Atsushi Sato, Ichihara-shi (JP)

(73) Assignee: IDEMITSU KOSAN CO., LTD, Tokyo (JP)

(21) Appl. No.: 18/118,215

(22) Filed: Mar. 7, 2023

(30) Foreign Application Priority Data
Mar. 31, 2022 (JP) 2022-061338

(51) Int. Cl. H01M 4/1397; H01M 10/0525; H01M 10/0562

(52) U.S. Cl. CPC H01M 4/1397; H01M 10/0525; H01M 10/0562; H01M 2300/0068

(57) ABSTRACT

Provided is a production method for a sulfide solid electrolyte capable of preventing generation of a hydrogen sulfide gas even when brought into contact with moisture while capable of preventing reduction in ionic conductivity, the method includes mixing a raw material inclusion containing at least two raw materials, the raw material inclusion contains at least one selected from a lithium atom, a sulfur atom, a phosphorus atom and a halogen atom, and the raw material inclusion contains modified P₂S₅. Also provided are the sulfide solid electrolyte produced by the method, an electrode mixture, a lithium ion battery, and a modified P₂S₅ for production of a sulfide solid electrolyte.

### TECHNICAL FIELD

The present invention relates to a sulfide solid electrolyte production method.

### BACKGROUND ART

As a solid electrolyte layer in a lithium ion battery, it is contemplated to use a sulfide solid electrolyte that uses diphosphorus pentasulfide (P₂S₅) or the like as a starting material. The sulfide solid electrolyte has a high lithium ionic conductivity (hereinafter it is simply referred to as ionic conductivity), but can readily react with water (hereinafter it also includes moisture) and oxygen, and especially when brought into contact with water, this generates a hydrogen sulfide (H₂S) gas, and accordingly, it is desired to reduce the amount of H₂S gas generated. In addition, such lithium ion batteries have another problem that adhesiveness between solid particles such as solid electrolytes is low. Against this, in PTL 1, an organic compound group is held by a covalent bond on the surface of inorganic solid electrolyte particles to improve the adhesiveness.

### CITATION LIST

### Patent Literature

PTL 1: WO 2017/111131 A

### SUMMARY OF INVENTION

### Technical Problem

It is described that the solid electrolyte described in PTL 1 carries organic compound groups homogeneously on its surface by covalent bonds. However, in the method described in PTL 1, since by-products such as Li salt are generated and cannot be removed, it is assumed that ion conduction is inhibited and battery characteristics are degraded. Further, as carrying an organic compound group, the solid electrolyte is previously surface treated or exposed to moisture, and it is considered difficult to maintain the ionic conductivity. In that manner, the technique of carrying an organic compound-derived group on the surfaces of solid electrolyte particles has both merits and demerits, and it has been difficult to satisfy all the desired performances in a balanced manner.

The present invention has been made in consideration of the situations, and its object is to provide a production method for a sulfide solid electrolyte capable of preventing generation of a hydrogen sulfide gas even when brought into contact with moisture while capable of preventing reduction in ionic conductivity, to provide the sulfide solid electrolyte, and further to provide an electrode mixture containing the sulfide solid electrolyte, a lithium ion battery, and a modified P₂S₅ for production of a sulfide solid electrolyte provided with an organic group.

### Solution to Problem

The production method for a sulfide solid electrolyte of the present invention is a production method for a sulfide solid electrolyte, including mixing a raw material inclusion containing at least two raw materials, wherein the raw material contains at least one selected from a lithium atom, a sulfur atom, a phosphorus atom and a halogen atom, and the raw material inclusion contains modified P₂S₅;

The sulfide solid electrolyte of the present invention is a sulfide solid electrolyte containing a lithium atom, a sulfur atom, a phosphorus atom, a halogen atom and an organic group, wherein the ratio of the content (mol) of sulfur atom, phosphorus atom and halogen atom per the content (mol) of lithium atom is lithium atom/sulfur atom/phosphorus atom/halogen atom=1/1.1000 to 1.2000/0.2000 to 0.3500/0.1400 to 0.1550;

The electrode mixture of the present invention is an electrode mixture containing the sulfide solid electrolyte and an electrode active material;

The lithium ion battery of the present invention is a lithium ion battery containing at least one of the sulfide solid electrolyte and the electrode mixture.

The modified P₂S₅ of the present invention is a modified P₂S₅ for production of the above-mentioned sulfide solid electrolyte provided with an organic group.

### Advantageous Effects of Invention

The present invention can provide a production method for a sulfide solid electrolyte capable of preventing generation of a hydrogen sulfide gas even when brought into contact with moisture while capable of preventing reduction in ionic conductivity (hereinafter this may also be described as waterproofness) and provide the sulfide solid electrolyte, and further can provide an electrode mixture containing the sulfide solid electrolyte, a lithium ion battery, and a modified P₂S₅ for production of a sulfide solid electrolyte provided with an organic group.

### BRIEF DESCRIPTION OF DRAWINGS

FIG. 1 is a flow chart of explaining one example of preferred modes of a production method of the present embodiment.

FIG. 2 is a schematic outline view of a test apparatus for use for waterproofness evaluation.

FIG. 3 shows X-ray diffraction spectra (XRD patterns) of the raw material inclusion containing modified P₂S₅ used in Example 1, and the electrolyte precursor (1), the amorphous sulfide solid electrolyte (1) and the crystalline sulfide solid electrolyte (1) produced in Example 1.

FIG. 4 is a graph showing a relationship between the amount of the modifier used and the amount of H₂S generated.

### DESCRIPTION OF EMBODIMENTS

Embodiments of the present invention (hereinafter sometimes referred to as “present embodiment”) are hereunder described. In this specification, numerical values of an upper limit and a lower limit according to numerical value ranges of “or more”, “or less”, and “XX to YY” are each a numerical value which can be arbitrarily combined, and numerical values in the section of Examples can also be used as numerical values of an upper limit and a lower limit, respectively.

### Knowledge That the Inventors Obtained in Reaching the Invention

The present inventors have made assiduous studies for solving the above-mentioned problems and, as a result, have found out the following matters and completed the present invention.

PTL 1 describes inorganic solid electrolyte particles carrying an organic compound group on the surfaces via a covalent bond. However, in PTL 1, attention is focused on the adhesiveness between solid particles, and the ionic conductivity of inorganic solid electrolyte particles having an organic compound group on the surfaces is not confirmed. In addition, the inorganic solid electrolyte particles contain a lithium atom, a phosphorus atom and a sulfur atom but do not contain a halogen atom.

Further, for surface modification of the inorganic solid electrolyte particles, the surfaces of the inorganic solid electrolyte particles are exposed to moisture in air and then reacted with an acid chloride to provide a structure having an ester group as a bonding group. In the method of PTL 1, the inorganic solid electrolyte particles are processed for carrying an organic compound group, and as a result, therefore, the resultant inorganic solid electrolyte particles after the treatment contain the impurities associated with this treatment, for example, a lithium salt of a carboxylic acid and a lithium halide. In addition, since the surfaces of the inorganic solid electrolyte particles are processed, it is considered that the ionic conductivity lowers and, further, it is considered that no organic group exists inside the inorganic solid electrolyte particles. Consequently, when the surface-modified inorganic solid electrolyte particles are ground by any force, surfaces that are not surface-modified are formed.

The present inventors paid special attention to modification of P₂S₅. The inventors have found that, when modified P₂S₅ is used in producing a sulfide solid electrolyte, the sulfide solid electrolyte produced can have a uniform surface, and additionally can have an effect that not only the surface but also the inside thereof can be modified. Further, by employing the present invention, the inventors have succeeded in preventing degradation by surface treatment and production of side products and in making the sulfide solid electrolyte carry an organic compound group while maintaining the ionic conductivity.

### Various Modes of the Present Embodiment

Hereinunder described are a production method for a sulfide solid electrolyte of the first modes to the eleventh modes of the present embodiment; a sulfide solid electrolyte of the twelfth mode; an electrode mixture of the thirteenth mode; a lithium ion battery of the fourteenth mode; and a modified P₂S₅ for production of a sulfide solid electrolyte of the fifteenth mode.

The production method for a sulfide solid electrolyte of the first mode of the present embodiment is:

a production method for a sulfide solid electrolyte, including mixing a raw material inclusion containing at least two raw materials, wherein the raw material contains at least one selected from a lithium atom, a sulfur atom, a phosphorus atom and a halogen atom, and the raw material inclusion contains modified P₂S₅.

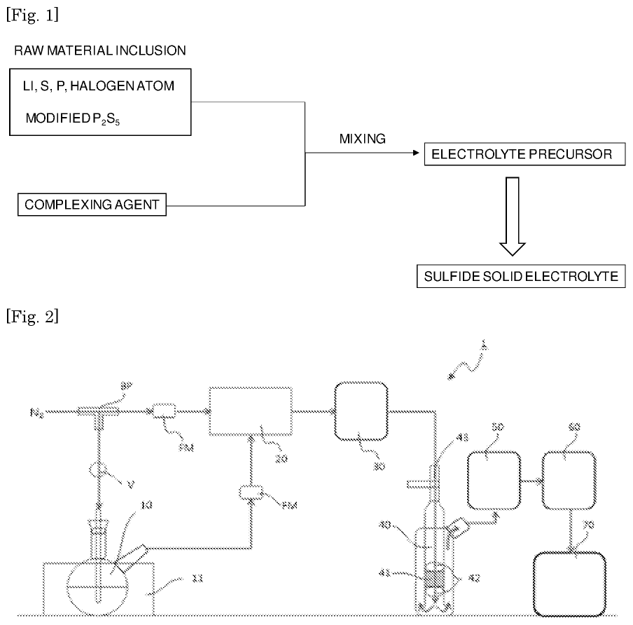

FIG. 1 is a flow chart of explaining a preferred mode of a production method for a sulfide solid electrolyte of the present embodiment. In the production method of the present embodiment, modified P₂S₅ is used in place of P₂S₅ used in conventional production methods. In the production process, the materials to be used are changed alone and it is unnecessary to change the conventional production apparatus, and merely with that, a sulfide solid electrolyte having more excellent characteristics than the sulfide solid electrolyte used in conventional production methods can be obtained.

“Modified P₂S₅” in the present application is P₂S₅ that has been modified, and means P₂S₅ whose chemical properties have changed owing to some modification given thereto. Details will be described later.

In PTL 1, only the surfaces of the inorganic solid electrolyte particles carry an organic compound group. However, when modified P₂S₅ is used as in the present embodiment, not only an effect of uniformly modifying the surfaces of the sulfide solid electrolyte produced can be attained but also an effect of even the inside thereof can be attained. Accordingly, while reduction of ionic conductivity is prevented, generation of a hydrogen sulfide gas can be prevented even when the sulfide solid electrolyte is brought into contact with moisture.

The generation amount of a hydrogen sulfide gas can be measured, for example, according to the method described in the section of Examples. A lower H₂S gas generation amount can be evaluated as higher waterproofness.

The production method for a sulfide solid electrolyte of the second mode of the present embodiment is a production method for a sulfide solid electrolyte of the first mode, wherein:

the modified P₂S₅ is P₂S₅ provided with an organic group.

When modified P₂S₅ is provided with an organic group, the sulfide solid electrolyte produced is provided with an organic group not only on the surface but also inside thereof, and therefore, it is preferred since, even when the sulfide solid electrolyte is brought into contact with moisture, generation of a hydrogen sulfide gas can be prevented. In particular, when modified P₂S₅ is provided with an organic group, the surface of the sulfide solid electrolyte produced can be uniformly provided with an organic group and consequently, a mechanism can be taken into consideration that the opportunity for moisture in the atmosphere to contact with the sulfide solid electrolyte is reduced, and generation of hydrogen sulfide gas is thereby suppressed.

“Provided with an organic group” means existence of an organic group on the surfaces and in the inside of granular P₂S₅, and is a concept that includes the attachment of an organic group to the surface of P₂S₅ and the incorporation inside the crystal structure thereof. Modified P₂S₅ is P₂S₅ provided with an organic group for modification. “Provided with” includes chemical bond, physical adsorption and coordinate bond.

The case where P₂S₅ provided with an organic group is used is preferred since the organic group can be uniformly distributed on the surface of the resultant sulfide solid electrolyte, and further can be distributed even inside the sulfide solid electrolyte.

The production method for a sulfide solid electrolyte of the third mode of the present embodiment is a production method for a sulfide solid electrolyte of the second mode, wherein:

the organic group contains a hetero atom.

When the organic group contains a hetero atom, the organic group can firmly bond with P₂S₅, and therefore the case is preferred since the organic group can be suppressed from dropping to reduce in the production process for the sulfide solid electrolyte, and even after taken in the sulfide solid electrolyte, the organic group can also be suppressed from reducing.

The production method for a sulfide solid electrolyte of the fourth mode of the present embodiment is a production method for a sulfide solid electrolyte of the third mode, wherein:

the modified P₂S₅ contains a covalent bond between the phosphorus atom of P₂S₅ in the modified P₂S₅ and the hetero atom.

The case where the phosphorus atom in the modified P₂S₅ bonds to the organic group via a covalent bond between the phosphorus atom and the hetero atom in the organic group is preferred since the organic group does not readily drop from the modified P₂S₅. This is also preferable as firmly bonding also to the sulfide solid electrolyte.

The production method for a sulfide solid electrolyte of the fifth mode of the present embodiment is a production method for a sulfide solid electrolyte of the third or fourth mode, wherein:

the hetero atom is at least one selected from a sulfur atom, an oxygen atom and a nitrogen atom.

The case where the above-mentioned term “provided with” is a chemical bond and where the hetero atom is the above-mentioned atom is preferred since the atom can readily form a chemical bond. The case where that “provided with” is physical adsorption or a coordinate bond is preferred since the atom has non-covalent electron pairs and therefore has large intermolecular force, or can form a coordinate bond with lithium atoms.

The production method for a sulfide solid electrolyte of the sixth mode of the present embodiment is a production method for a sulfide solid electrolyte of any of the second to fifth modes, wherein:

the organic group is at least one selected from groups of general formulae (a-1), (a-2) and (b-1):

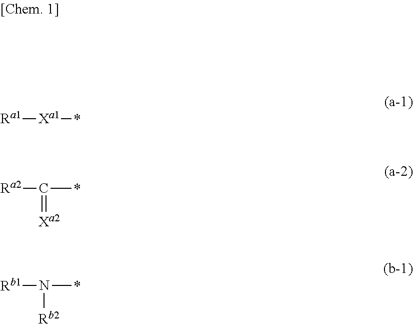

In the formulae, * indicates a bonding site to P₂S₅, R^{a1}, R^{a2}, R^{b1} and R^{b2} each independently represent a monovalent organic group, X^{a1} and X^{a2} each independently represent an oxygen atom or a sulfur atom.

Diphosphorus pentasulfide is represented by a molecular formula P₄S₁₀ and is known to have the following steric structure.

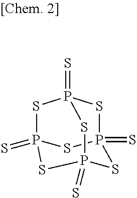 [SMILES: S=P12SP3(=S)SP(=S)(S1)SP(=S)(S2)S3]

When diphosphorus pentasulfide reacts with, for example, two molecules of a thiol derivative, it forms a thiophosphate while generating one molecule of hydrogen sulfide (H₂S).

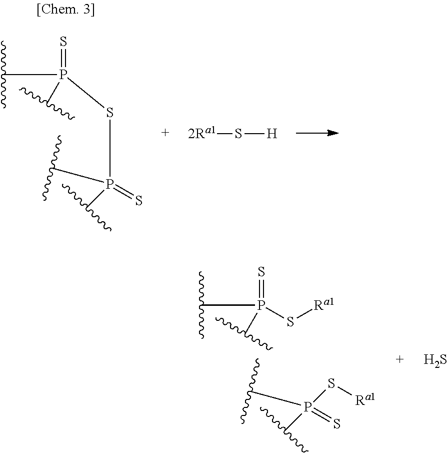

Similarly, it also reacts with a carboxylic acid derivative, a thiocarboxylic acid derivative and an amine derivative.

Accordingly, the case where the group represented by the general formula (a-1), (a-2) or (b-1) bonds to the phosphorus atom in modified P₂S₅ via a covalent bond is preferred since the organic group firmly bonds.

In the case of the group represented by the general formula (a-1), (a-2) or (b-1), the covalent bond is —P—S—, —P—O—, —P—C(═O)—, —P—O—C(═O)—, —P—C(═O)—, —P—S—C(═O)—, —P—S—C(═S)—, or —P—N<.

When the organic group has the above-described structure, the organic group can firmly bond with P₂S₅, and therefore the case is preferred since the organic group can be suppressed from dropping to reduce in the production process for the sulfide solid electrolyte, and even after taken in the sulfide solid electrolyte, the organic group can also be suppressed from reducing.

The production method for a sulfide solid electrolyte of the seventh mode of the present embodiment is a production method for a sulfide solid electrolyte of any of the first to sixth modes, wherein:

a stirring machine, a mixing machine or a grinding machine is used in the mixing.

The case where a stirring machine, a mixing machine or a grinding machine is used is preferred since a homogeneous sulfide solid electrolyte can be produced in a short period of time.

The production method for a sulfide solid electrolyte of the eighth mode of the present embodiment is a production method for a sulfide solid electrolyte of any of the first to seventh modes, wherein:

the raw material inclusion and a complexing agent are mixed in the mixing.

The case where a complexing agent is used is preferred since the energy amount to be devoted in mixing can be reduced.

The production method for a sulfide solid electrolyte of the ninth mode of the present embodiment is a production method for a sulfide solid electrolyte of any of the first to eighth modes, wherein:

the mixing is performed in a solvent.

The case where mixing is performed in a solvent is preferred since the mixing is facilitated and the mixing time can be shortened.

The production method for a sulfide solid electrolyte of the tenth mode of the present embodiment is a production method for a sulfide solid electrolyte of any of the first to ninth modes;

which further includes heating.

By heating, as described below, an amorphous sulfide solid electrolyte can be crystallized and the crystallite diameter can be enlarged, and in addition, in the case where a complexing agent is used, the complexing agent can be removed from the formed complex, which is preferable since the ionic conductivity is enlarged.

The production method for a sulfide solid electrolyte of the eleventh mode of the present embodiment is a production method for a sulfide solid electrolyte of any of the first to tenth modes;

wherein the sulfide solid electrolyte contains a thio-LISICON Region II-type crystal structure.

The sulfide solid electrolyte containing a thio-LISICON Region II-type crystal structure is preferred since the ionic conductivity can be enlarged.

The sulfide solid electrolyte of the twelfth mode of the present embodiment is a sulfide solid electrolyte containing:

a lithium atom, a sulfur atom, a phosphorus atom and a halogen atom and also an organic group, wherein the ratio of the content (mol) of sulfur atom, phosphorus atom and halogen atom per the content (mol) of lithium atom is lithium atom/sulfur atom/phosphorus atom/halogen atom=1/1.1000 to 1.2000/0.2000 to 0.3500/0.1400 to 0.1550.

The sulfide solid electrolyte of the present embodiment is one obtained in any of the first to tenth modes mentioned above, the sulfide solid electrolyte of the type is preferable as having a high ionic conductivity and capable of suppressing generation of a hydrogen sulfide gas even when brought into contact with moisture.

The electrode mixture of the thirteenth mode of the present embodiment is an electrode mixture containing:

the sulfide solid electrolyte of the twelfth mode, and an electrode active material.

The sulfide solid electrolyte of the twelfth mode has a high ionic conductivity and can suppress generation of a hydrogen sulfide gas even when brought into contact with moisture, and consequently, the electrode mixture using this can have excellent characteristics.

The lithium ion battery of the fourteenth mode of the present embodiment is a lithium ion battery containing:

at least one of the sulfide solid electrolyte of the twelfth mode and the electrode mixture of the thirteenth mode.

The sulfide solid electrolyte and the electrode mixture have excellent characteristics as mentioned above, and therefore the lithium ion battery using it can have excellent battery characteristics.

The modified P₂S₅ of the fifteenth mode of the present invention is:

a modified P₂S₅ for production of a sulfide solid electrolyte provided with an organic group.

The modified P₂S₅ is provided with an organic group and therefore, among modified P₂S₅, especially this can more readily exhibit excellent effects as having an organic group. The case where the modified P₂S₅ is contained in the raw material inclusion for use in the production method for a sulfide solid electrolyte of the second to eleventh modes is preferred since the sulfide solid electrolyte produced can have a high ionic conductivity and can suppress generation of a hydrogen sulfide gas even when brought into contact with moisture.

Hereinunder the sulfide solid electrolyte, the production method for sulfide solid electrolyte, the electrode mixture, and the lithium ion battery of the present embodiment are described in more detail with reference to the above-mentioned modes of the embodiment.

### [Production Method for Sulfide Solid Electrolyte]

The production method for a sulfide solid electrolyte of the present embodiment is a production method including mixing a raw material inclusion containing at least two raw materials, wherein the raw material contains at least one selected from a lithium atom, a sulfur atom, a phosphorus atom and a halogen atom, and the raw material inclusion contains modified P₂S₅.

In the present specification, “sulfide solid electrolyte” means an electrolyte that maintains solid in a nitrogen atmosphere at 25° C. The sulfide solid electrolyte in the present embodiment contains a lithium atom, a sulfur atom, a phosphorus atom and a halogen atom and also an organic group, and has ionic conductivity caused owing to the lithium atom.

In the present specification, “containing” and “containing as a constituent element” include not only the case of “contain” literally as it is as phrases, but also other cases of bonding to any other atom or to any other molecule to “contain”, for example, a case of retaining the constitution of the compounds used in mixing, in which, therefore at least one atom constituting the compound bonds to at least one atom constituting the other compound.

The “sulfide solid electrolyte” includes both the crystalline sulfide solid electrolyte having a crystal structure produced according to the production method of the present embodiment and an amorphous sulfide solid electrolyte. The crystalline sulfide solid electrolyte as referred to in this specification is a material that is a sulfide solid electrolyte in which peaks derived from the sulfide solid electrolyte are observed in an X-ray diffraction pattern in the X-ray diffractometry, and the presence or absence of peaks derived from the raw materials of the sulfide solid electrolyte does not matter. That is, the crystalline sulfide solid electrolyte contains a crystal structure derived from the sulfide solid electrolyte, in which a part thereof may be a crystal structure derived from the sulfide solid electrolyte, or all of them may be a crystal structure derived from the sulfide solid electrolyte. The crystalline sulfide solid electrolyte may be one in which an amorphous sulfide solid electrolyte is contained in a part thereof so long as it has the X-ray diffraction pattern as mentioned above. In consequence, in the crystalline sulfide solid electrolyte, a so-called glass ceramics which is obtained by heating the amorphous sulfide solid electrolyte to a crystallization temperature or higher is contained.

The amorphous sulfide solid electrolyte as referred to in this specification is a halo pattern in which any other peak than the peaks derived from the materials is not substantially observed in an X-ray diffraction pattern in the X-ray diffractometry, and it is meant that the presence or absence of peaks derived from the raw materials of the sulfide solid electrolyte does not matter.

The production method for a sulfide solid electrolyte of the present embodiment needs to include mixing a raw material inclusion containing at least two raw materials. As described in FIG. 1, a complexing agent to be mentioned below can be used, and as needed, the process can include heating via formation of an electrolyte precursor.

Details of the electrolyte precursor will be described later, and the electrolyte precursor is a complex obtained by mixing a complexing agent and a sulfide solid electrolyte.

Because of the reason that a sulfide solid electrolyte may undergo accelerated hydrolysis by contact with moisture such as moisture in air, the sulfide solid electrolyte may generate hydrogen sulfide. Consequently, it is ideal that the production process for a sulfide solid electrolyte and a battery is performed under a low dew point environment with low moisture, but it is economically and physically difficult to carry out all the process at a low dew point, and in fact, it is desired to provide a sulfide solid electrolyte capable of being handled at a high dew point on a dry room level (for example, dew point −60 to −20° C.).

In a production method using a complexing agent, production at high dew point is possible, which can exhibit an excellent effect for scaling up the production process.

Using the above-mentioned modified P₂S₅, an organic group to be mentioned later can be introduced into a sulfide solid electrolyte. The case of using unmodified P₂S₅ along with modified P₂S₅ in a raw material inclusion is preferred since the amount of the organic group that the sulfide solid electrolyte contains can be controlled, but for simplifying the production process, the raw material inclusion preferably contains modified P₂S₅ alone.

As described below, it is preferable to control the amount of the organic group that the sulfide solid electrolyte contains by controlling the amount of the organic group that modified P₂S₅ contains.

### <Mixing>

In the production method of the present embodiment, mixing is not specifically limited so far as a raw material inclusion containing at least two raw materials is mixed, and any of a liquid-phase method or a solid-phase method can be employed for mixing. The liquid-phase method may be a homogeneous method where the raw material inclusion is completely dissolved in a solvent and mixed, or a heterogeneous method where the raw material inclusion is not completely dissolved and is mixed via a suspension containing both liquid and solid.

Mixing can be mixing of the above-mentioned raw material inclusion and a complexing agent to be mentioned below. The case of using a complexing agent is preferred since a sulfide solid electrolyte can be produced by mixing not at a high temperature.

From the viewpoint that, in the mixing step, granulation to enlarge the particle size does not occur, and that production is possible with a simple apparatus at a low temperature, the step is preferably performed in a solvent such as in a homogenous method or a heterogeneous method, and from the viewpoint of attaining a high ionic conductivity and from the viewpoint of reducing the environmental load in use of solvent, a solid-phase method is preferred.

The raw material inclusion can be solid or liquid, but is generally solid or slurry as mentioned below.

The method of mixing the raw material inclusion containing at least two raw materials is not specifically limited, and the raw material inclusion containing at least two raw materials prepared individually can be put into an apparatus in which the raw material inclusion containing at least two raw materials can be mixed. For shortening the mixing time, the mixing is preferably performed in a solvent to be mentioned below.

In the production method of the present embodiment, mixing includes stirring and grinding in addition to mere mixing. In mixing, preferably employed is a stirring machine, a mixing machine or a grinding machine, and more preferably, a stirring machine and a mixing machine are used.

One example of the stirring machine and the mixing machine is a mechanical stirring mixer equipped with a stirring blade inside the tank. The mechanical stirring mixer includes a high-speed stirring mixer and a double-arm type mixer. From the viewpoint of enhancing the uniformity of the raw materials in the mixture of a raw material inclusion and a complexing agent to thereby attain a higher ionic conductivity, a high-speed stirring mixer is preferably used. The high-speed stirring mixer includes a vertical axis rotating mixer and a lateral axis rotating mixer, and any of these types of mixers can be used.

Examples of a shape of the impeller which is used in the mechanically stirring-type mixer include a blade type, an arm type, an anchor type, a paddle type, a full-zone type, a ribbon type, a multistage blade type, a double arm type, a shovel type, a twin-shaft blade type, a flat blade type, a C-type blade type, an anchor type, a paddle type, and a full-zone type. From the viewpoint of enhancing the uniformity of the raw materials in the raw material inclusion to thereby attain a higher ionic conductivity, a shovel type, a flat blade type and a C-type blade type are preferred.

For small amount production, stirring using a stirring bar can be employed.

The temperature condition in stirring the raw material inclusion and optionally a complexing agent and also optionally a solvent is not specifically limited, and can be, for example, −30 to 100° C., but preferably −10 to 50° C., more preferably room temperature (23° C.) or so (for example, room temperature ±5° C. or so). The mixing time can be 0.1 to 150 hours or so, but from the viewpoint of more uniformly mixing them to attain a higher ionic conductivity, the time is preferably 0.2 to 120 hours, more preferably 0.3 to 100 hours, even more preferably 0.5 to 80 hours.

As a more specific device of a grinding machine, for example, there can be mentioned a medium-assisted grinding machine. The medium-assisted grinding machine can be grouped into a vessel driving grinding machine and a medium-stirring grinding machine.

The vessel driving grinding machine includes a stirring tank, a grinding tank, or a combination thereof such as a ball mill and bead mill. As a ball mill and a bead mill, any type is employable including a rotation type, a tumbler type, a vibration type and a planetary type.

The medium-stirring grinding machine includes various grinding machines, such as an impact grinder such as a cutter mill, a hammer mill and a pin mill; a tower grinder such as a tower mill; a stirrer tank grinder such as an attritor, an Aquamizer, and a sand grinder; a circulation tank grinder such as a Viscomill, and a pearl mill; a flow tube grinder; an annular grinder such as a co-ball mile; and a continuous dynamic grinder.

The grain size of the medium to be used in the bead mill or the ball mill can be appropriately determined in consideration of the kind and the particle size the raw materials used, and also the kind and the scale of the apparatus to be used, but in general, it is preferably 0.01 mm or more, more preferably 0.015 mm or more, even more preferably 0.02 mm or more, further more preferably 0.04 mm or more, and the upper limit is preferably 3 mm or less, more preferably 2 mm or less, even more preferably 1 mm or less, further more preferably 0.8 mm or less.

Examples of the material of the medium include metals such as stainless, chrome steel, and tungsten carbide; ceramics such as zirconia and silicon nitride; and minerals such as agate.

In the case of using a ball mill or a bead mill, the number of rotations varies depending on the scale of the processing, and therefore cannot be generally said, but is typically 10 to 1000 rpm, preferably 20 to 900 rpm.

The grinding time in that case also varies depending on the scale of the processing, and therefore cannot be generally said, but is typically 0.5 to 100 hours, preferably 1 to 72 hours, more preferably 5 to 48 hours.

### (Drying)

The production method for a sulfide solid electrolyte of the present embodiment can include drying an electrolyte precursor and/or a sulfide solid electrolyte. By the treatment, the complexing agent and the solvent existing as liquid can be removed to give a powder of electrolyte precursor and/or sulfide solid electrolyte. By previously drying, subsequent heating treatment to be mentioned below can be efficiently attained. Drying and subsequent heating can be carried out in one and the same step.

Drying an electrolyte precursor and/or a sulfide solid electrolyte can be performed at a temperature depending on the kind of the solvent and the complexing agent remaining therein (complexing agent not taken into the substance targeted for drying). For example, the drying can be performed at a temperature not lower than the boiling point of the solvent and the complexing agent. In addition, the drying can be performed through drying under reduced pressure (vacuum drying) using a vacuum pump or the like at typically 5 to 100° C., preferably 10 to 85° C., more preferably 15 to 70° C., and still more preferably around room temperature (23° C.) (for example, room temperature±about 5° C.), to volatilize the complexing agent.

Drying the electrolyte precursor and/or the sulfide solid electrolyte can be performed by filtration using a glass filer, solid-liquid separation though decantation, or solid-liquid separation with a centrifuge. In the present embodiment, after performing the solid-liquid separation, the drying can be performed under the aforementioned temperature condition.

Specifically, for the solid-liquid separation, decantation in which the complexing agent and the solvent to be a supernatant after precipitation of the electrolyte precursor and/or the sulfide solid electrolyte are removed, or filtration with a glass filter having a pore size of, for example, about 10 to 200 μm, preferably 20 to 150 μm, is easy.

### <Heating>

The production method for a sulfide solid electrolyte of the present embodiment preferably further includes heating the electrolyte precursor and/or the sulfide solid electrolyte after mixing. Namely, the production method preferably includes heating the electrolyte precursor to obtain an amorphous sulfide solid electrolyte to be mentioned below, or heating the electrolyte precursor or the amorphous sulfide solid electrolyte to obtain a crystalline sulfide solid electrolyte to be mentioned below.

By heating the electrolyte precursor, the complexing agent and the solvent are removed from the electrolyte precursor, and an amorphous sulfide solid electrolyte or a crystalline sulfide solid electrolyte containing a lithium atom, a sulfur atom, a phosphorus atom and a halogen atom can be obtained. The electrolyte precursor to be heated in this step can be a ground product of the electrolyte precursor prepared by grinding in the manner to be mentioned below.

Also the case of heating the crystalline sulfide solid electrolyte is preferred since the crystalline diameter can be enlarged and the ionic conductivity can be increased.

Here, the fact that the complexing agent is removed from the electrolyte precursor is obvious from the results of the X-ray diffraction pattern and gas chromatography which confirm that the complexing agent forms a co-crystal with a precursor. In addition to this, this is supported by the fact that the X-ray diffraction pattern of the sulfide solid electrolyte obtained by removal of the complexing agent achieved by heating the electrolyte precursor is the same as that of the sulfide solid electrolyte obtained according to a conventional method not using a complexing agent.

In the production method of the present embodiment, the sulfide solid electrolyte can be obtained by heating the electrolyte precursor so as to remove the complexing agent from the electrolyte precursor, and the amount of the complexing agent in the sulfide solid electrolyte is preferably as small as possible. However, the complexing agent can remain in the the sulfide solid electrolyte to such a degree that does not have some negative influence on the performance of the sulfide solid electrolyte. The content of the complexing agent in the sulfide solid electrolyte can be generally 10% by mass or less, preferably 5% by mass or less, more preferably 3% by mass or less, even more preferably 1% by mass or less. Since the content is preferably as small as possible, the lower limit is not specifically limited.

In order to obtain a crystalline sulfide solid electrolyte in the production method of the present embodiment, the electrolyte precursor can be heated, or the electrolyte precursor is heated to give an amorphous sulfide solid electrolyte and then the amorphous sulfide solid electrolyte can be heated. Namely, in the production method of the present embodiment, an amorphous sulfide solid electrolyte can also be produced.

Heretofore, for obtaining a crystalline sulfide solid electrolyte having a high ionic conductivity, for example, a sulfide solid electrolyte having a thio-LISICON Region II-type crystal structure to be mentioned below, it is necessary to prepare an amorphous sulfide solid electrolyte by mechanical grinding treatment such as mechanical milling or by any other melting and rapidly cooling treatment, and then to heat the resultant amorphous sulfide solid electrolyte. However, in the production method of the present embodiment, a crystalline sulfide solid electrolyte having a thio-LISICON Region II-type crystal structure can be obtained without mechanical grinding treatment or any other melting and rapidly cooling treatment, and the production method of the present embodiment can be said to be superior to the conventional production method with mechanical milling treatment.

In the production method of the sulfide solid electrolyte of the present embodiment, whether or not the amorphous sulfide solid electrolyte is obtained, whether or not the crystalline sulfide solid electrolyte is obtained, whether or not the crystalline sulfide solid electrolyte is obtained after obtaining the amorphous sulfide solid electrolyte, or whether or not the crystalline sulfide solid electrolyte is obtained directly from the electrolyte precursor is appropriately selected according to the intended purpose, and is able to be adjusted by the heating temperature, the heating time, or the like.

For example, in the case of obtaining the amorphous sulfide solid electrolyte, the heating temperature of the electrolyte precursor may be determined according to the structure of the crystalline sulfide solid electrolyte which is obtained by heating the amorphous sulfide solid electrolyte (or the electrolyte precursor). Specifically, the heating temperature may be determined by subjecting the amorphous sulfide solid electrolyte (or the electrolyte precursor) to differential thermal analysis (DTA) with a differential thermal analysis device (DTA device) under a temperature rise condition of 10° C./min and adjusting the temperature to a range of preferably 5° C. or lower, more preferably 10° C. or lower, and still more preferably 20° C. or lower starting from a peak top temperature of the exothermic peak detected on the lowermost temperature side. Although a lower limit thereof is not particularly restricted, it may be set to a temperature of about [(peak top temperature of the exothermic peak detected on the lowermost temperature side) −40° C.] or higher. By regulating the heating temperature to such a temperature range, the amorphous sulfide solid electrolyte is obtained more efficiently and surely.

The heating temperature for obtaining the amorphous sulfide solid electrolyte cannot be categorically defined as varying depending on the structure of the resultant crystalline sulfide solid electrolyte, but in general, it is preferably 250° C. or lower, more preferably 220° C. or lower, even more preferably 200° C. or loser. The lower limit is not specifically limited but is preferably 90° C. or higher, more preferably 100° C. or higher, even more preferably 110° C. or higher.

Preferably, heating is performed under reduced pressure. From the apparatus perspective, the pressure is preferably 0.1 Pa or more, more preferably 1.0 Pa or more, even more preferably 5.0 Pa or more. From the viewpoint of obtaining a solid electrolyte having a high ionic conductivity, the pressure is preferably 100.0 Pa or less, more preferably 50.0 Pa or less, even more preferably 20.0 Pa or less.

In the case of obtaining the crystalline sulfide solid electrolyte by heating the amorphous sulfide solid electrolyte or in the case of directly obtaining it from the electrolyte precursor, the heating temperature may be determined according to the structure of the crystalline sulfide solid electrolyte, and it is preferably higher than the aforementioned heating temperature for obtaining the amorphous sulfide solid electrolyte. Specifically, the heating temperature may be determined by subjecting the amorphous sulfide solid electrolyte (or the precursor) to differential thermal analysis (DTA) with a differential thermal analysis device (DTA device) under a temperature rise condition of 10° C./min and adjusting the temperature to a range of preferably 5° C. or higher, more preferably 10° C. or higher, and still more preferably 20° C. or higher starting from a peak top temperature of the exothermic peak detected on the lowermost temperature side. Although an upper limit thereof is not particularly restricted, it may be set to a temperature of about 40° C. or lower. By regulating the heating temperature to such a temperature range, the crystalline sulfide solid electrolyte is obtained more efficiently and surely. Although the heating temperature for obtaining the crystalline sulfide solid electrolyte cannot be unequivocally prescribed because it varies with the structure of the resultant crystalline sulfide solid electrolyte, in general, it is preferably 130° C. or higher, more preferably 135° C. or higher, and still more preferably 140° C. or higher. Although an upper limit of the heating temperature is not particularly limited, it is preferably 300° C. or lower, more preferably 280° C. or lower, and still more preferably 250° C. or lower.

Although the heating time is not particularly limited so long as it is a time for which the desired amorphous sulfide solid electrolyte or crystalline sulfide solid electrolyte is obtained, for example, it is preferably 1 minute or more, more preferably 10 minutes or more, still more preferably 30 minutes or more, and yet still more preferably 1 hour or more. In addition, though an upper limit of the heating time is not particularly restricted, it is preferably 24 hours or less, more preferably 10 hours or less, still more preferably 5 hours or less, and yet still more preferably 3 hours or less.

It is preferred that the heating is performed in an inert gas atmosphere (for example, a nitrogen atmosphere and an argon atmosphere) or in a reduced pressure atmosphere (especially, in vacuo). This is because deterioration (for example, oxidation) of the crystalline sulfide solid electrolyte can be prevented from occurring. Although a method for heating is not particularly limited, for example, a method of using a hot plate, a vacuum heating device, an argon gas atmosphere furnace, or a firing furnace can be adopted. In addition, industrially, a lateral dryer or a lateral vibration fluid dryer provided with a heating means and a feed mechanism, or the like may be selected according to the heating treatment amount.

### Grinding

The production method for a sulfide solid electrolyte of the present embodiment preferably further includes grinding the electrolyte precursor and/or the sulfide solid electrolyte. By grinding the electrolyte precursor and/or the sulfide solid electrolyte, a sulfide solid electrolyte having a small particle size while suppressing reduction in the ionic conductivity can be obtained.

As the grinding machine for use in the present embodiment, the grinding machine mentioned above can be used.

By controlling the peripheral speed of the rotor of the grinding machine, pulverizing (particle size reduction) and granulation (particle growth) of the solid electrolyte can be controlled. Specifically, in addition to mixing in the method, the average particle size can be reduced by pulverization, or the average particle size can be enlarged by granulation, and therefore in this, the morphology of the sulfide solid electrolyte can be readily controlled in any desired manner. More specifically, by rotating the rotor at a low peripheral speed, pulverization can be attained, and by rotating the rotor at a high peripheral speed, granulation can be attained. In that manner, merely by controlling the peripheral speed of the rotor, the morphology of the solid electrolyte can be controlled easily.

Regarding the peripheral speed of the rotor, low peripheral speed and high peripheral speed can vary, for example, depending on the particle size, the material and the amount used of the media for use in the pulverizing machine, and therefore cannot be indiscriminately defined. For example, in the case of a device not using a grinding medium such as balls or beads like a high-speed revolving thin-film stirrer, pulverization can mainly occur even at a relatively high peripheral speed, and granulation can occur hardly. On the other hand, in the case of an apparatus using a grinding medium such as ball mills or bead mills, pulverization can be attained even at a low peripheral speed as described above, and granulation is possible at a high peripheral speed. Accordingly, under the same condition for the pulverizing apparatus and the pulverizing medium, the peripheral speed that enables pulverization is smaller than the peripheral speed that enables granulation. Consequently, for example, under the condition under which granulation is possible at a borderline peripheral speed of 6 m/sec, low peripheral speed means less than 6 m/sec, and high peripheral speed means 6 m/sec or more.

In grinding (mechanical treatment) the sulfide solid electrolyte, from the viewpoint of more easily controlling the desired morphology, a vessel driving grinding machine is preferred among the above-mentioned grinding machine. Above all, a bead mill and a ball mill are preferred. The vessel driving grinding machine such as a bead mill and a ball mill is equipped with a vessel such as a stirring tank and a grinding tank for containing the precursor for mechanical treatment, as a rotor capable of stirring the precursor for mechanical treatment. Accordingly, as mentioned above, by controlling the peripheral speed of the rotor, the morphology of the sulfide solid electrolyte can be readily controlled.

The bead mill and the ball mill can make it possible to control morphology by controlling the grain size, the material and the amount to be used of the beads and the balls to be used, and therefore these enable adjustment of a finer morphology, and also enable adjustment of a morphology heretofore unknown. For example, as a bead mill, herein employable is a centrifuge-type mill in which ultrafine beads (φ 0.015 to 1 mm or so) of so-called microbeads can be used (for example, Ultra Apex Mill, UAM).

Regarding morphology control, the average particle size can be reduced (pulverization) by reducing the energy to be given to the solid electrolyte, that is, by lowering the peripheral speed of the rotor, or by reducing the particle size of the beads or balls, and as a result, the specific surface area tends to increase, while on the other hand, by increasing the energy, that is, by increasing the peripheral speed of the rotor, or by increasing the particle size of the beads or balls, the average particle size can increase (granulation) and, as a result, the specific surface area tends to reduce.

In addition, for example, by prolonging the time for mechanical treatment, the average particle size tends to increase (granulation).

The treatment time for mechanical treatment can be appropriately determined in consideration of the desired morphology and also the kind and the scale of the apparatus to be used, but in general, it is preferably 5 seconds or more, more preferably 30 seconds or more, even more preferably 3 minutes or more, further more preferably 15 minutes or more, and the upper limit is preferably 5 hours or less, more preferably 3 hours or less, even more preferably 2 hours or less, further more preferably 1.5 hours or less.

The peripheral speed of the rotor in mechanical treatment (rotation speed in the apparatus such as bead mill and ball mill) can be appropriately determined in consideration of the desired morphology and also the kind and the scale of the apparatus to be used, but in general, it is preferably 0.5 m/sec or more, more preferably 1 m/sec or more, even more preferably 2 m/sec or more, further more preferably 3 m/sec or more, and the upper limit is preferably 55 m/sec or less, more preferably 40 m/sec or less, even more preferably 25 m/sec or less, further more preferably 15 m/sec or less. The peripheral speed can be the same during the process but can change on the way.

### [Sulfide Solid Electrolyte]

The sulfide solid electrolyte of the present embodiment can be produced easily according to the above-mentioned production method for a sulfide solid electrolyte of the present embodiment. Using modified P₂S₅ having an organic group, the sulfide solid electrolyte can be produced easily. In another mode, the sulfide solid electrolyte contains a lithium atom, a sulfur atom, a phosphorus atom and a halogen atom and also an organic group, wherein the ratio of the content (mol) of sulfur atom, phosphorus atom and halogen atom per the content (mol) of lithium atom is lithium atom/sulfur atom/phosphorus atom/halogen atom=1/1.1000 to 1.2000/0.2000 to 0.3500/0.1400 to 0.1550.

When the content ratio is not satisfied, a desired ionic conductivity cannot be obtained.

The sulfide solid electrolyte of the present embodiment needs to contain an organic group. Preferably, for improving waterproofness, the content of the organic group is preferably 0.005 mol or more relative to 1 mol of the phosphorus atom in the sulfide solid electrolyte, more preferably 0.01 mol or more, even more preferably 0.03 mol or more, and for preventing reduction in the ionic conductivity of the sulfide solid electrolyte, the content is preferably 0.50 mol or less, more preferably 0.30 mol or less, even more preferably 0.20 mol or less, further more preferably 0.15 mol or less.

The sulfide solid electrolyte of the present embodiment has excellent waterproofness and, even when exposed to moisture in air, it can suppress generation of a hydrogen sulfide gas. The H₂S generation amount is preferably 1.70 cc/g or less, more preferably 1.60 cc/g or less, even more preferably 1.50 cc/g or less, further more preferably 1.00 cc/g or less. The H₂S generation amount is preferably as small as possible, and the lower limit is not specifically limited.

The H₂S generation amount can be measured, for example, according to the method described in the section of Examples.

The value of a ratio of the modifying agent (mol) to the phosphorus atom (mol) in the sulfide solid electrolyte (modifying agent/P) can be presumed from the amount of the modifying agent used in producing modified P₂S₅ and the amount of P₂S₅ used.

The content of the phosphorus atom in the sulfide solid electrolyte can be determined by analysis with an inductivity coupled plasma (ICP) optical emission spectrometer described in the section of Examples. The content of the organic group can be determined by appropriately combining a Fourier transform infrared spectrophotometer (FT-IR), a solid nuclear magnetic resonance (NMR) method, a gas chromatography and a gas chromatography-mass spectroscopy analyzer (GC-Mass), focusing on the characteristic functional group that the organic group has.

The modifying agent is a chemical agent to be used for introducing an organic group into P₂S₅, as described below.

The “solid electrolyte” as referred to in this specification means an electrolyte of keeping the solid state at 25° C. in a nitrogen atmosphere. The “sulfide solid electrolyte” is a solid electrolyte containing a lithium atom, a sulfur atom, a phosphorus atom, and a halogen atom and having an ionic conductivity to be caused owing to the lithium atom.

The “sulfide solid electrolyte” includes both a crystalline sulfide solid electrolyte having a crystal structure and an amorphous sulfide solid electrolyte. In the present specification, the crystalline sulfide solid electrolyte is a sulfide solid electrolyte in which peaks derived from the sulfide solid electrolyte are observed in an X-ray diffraction pattern in the X-ray diffractometry, and the presence or absence of peaks derived from raw materials to be mentioned below does not matter. That is, the crystalline sulfide solid electrolyte contains a crystal structure derived from the sulfide solid electrolyte, in which a part thereof may be a crystal structure derived from the sulfide solid electrolyte, or all of them may be a crystal structure derived from the sulfide solid electrolyte. The crystalline sulfide solid electrolyte may be one in which an amorphous sulfide solid electrolyte is contained in a part thereof so long as it has the X-ray diffraction pattern as mentioned above. The crystalline sulfide solid electrolyte may not contain an amorphous sulfide solid electrolyte. Rather the crystalline sulfide solid electrolyte preferably contains an amorphous component because of easy processability thereof in fabricating batteries. In consequence, in the crystalline sulfide solid electrolyte, a so-called glass ceramics which is obtained by heating the amorphous sulfide solid electrolyte to a crystallization temperature or higher is contained. In order to increase the ionic conductivity, glass ceramics are preferred.

The amorphous sulfide solid electrolyte as referred to in this specification is one that gives a halo pattern, that is, the X-ray diffraction pattern in X-ray diffractometry has substantially no peaks. It is meant that the presence or absence of peaks derived from the raw materials for the sulfide solid electrolyte, or the presence or absence of minor crystals to be inevitably formed in operation for isolating the amorphous sulfide solid electrolyte does not matter.

### Amorphous Sulfide Solid Electrolyte

In the sulfide solid electrolyte of the present embodiment, the amorphous sulfide solid electrolyte contains a lithium atom, a sulfur atom, a phosphorus atom, and a halogen atom. As representative examples thereof, there are preferably exemplified sulfide solid electrolytes constituted of lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr; and sulfide solid electrolytes further containing other atom, such as an oxygen atom and a silicon atom, for example, Li₂S—P₂S₅—Li₂O—LiI and Li₂S—SiS₂—P₂S₅—LiI. From the viewpoint of obtaining a higher ionic conductivity, sulfide solid electrolytes constituted of lithium sulfide, phosphorus sulfide, and a lithium halide, such as Li₂S—P₂S₅—LiI, Li₂S—P₂S₅—LiCl, Li₂S—P₂S₅—LiBr, and Li₂S—P₂S₅—LiI—LiBr, are preferred.

The kinds of the atoms constituting the amorphous sulfide solid electrolyte can be confirmed by, for example, an inductivity coupled plasma optical emission spectrometer (ICP).

In the sulfide solid electrolyte of the present embodiment where the amorphous sulfide solid electrolyte has at least Li₂S—P₂S₅, from the viewpoint of obtaining a higher ionic conductivity, a molar ratio of Li₂S to P₂S₅ is preferably (65 to 85)/(15 to 35), more preferably (70 to 80)/(20 to 30), and still more preferably (72 to 78)/(22 to 28).

In the case where the amorphous sulfide solid electrolyte obtained in the production method for a sulfide solid electrolyte of the present embodiment is, for example, Li₂S—P₂S₅—LiI—LiBr, the total content of lithium sulfide and phosphorus pentasulfide is preferably 60 to 95 mol %, more preferably 65 to 90 mol %, and still more preferably 70 to 85 mol %. In addition, a proportion of lithium bromide relative to the total of lithium bromide and lithium iodide is preferably 1 to 99 mol %, more preferably 20 to 90 mol %, still more preferably 40 to 80 mol %, and especially preferably 50 to 70 mol %.

In the amorphous sulfide solid electrolyte of the sulfide solid electrolyte of the present embodiment, the ratio of the content (mol) of sulfur atom, phosphorus atom and halogen atom per the content (mol) of lithium atom is preferably lithium atom/sulfur atom/phosphorus atom/halogen atom=1/1.1000 to 1.2000/0.2000 to 0.3500/0.1400 to 0.1550, since the ionic conductivity of the sulfide solid electrolyte produced using it can be increased. More preferably, 1/1.1200 to 1.1800/0.2400 to 0.3200/0.1410 to 0.1500, even more preferably 1/1.1300 to 1.1700/0.2700 to 0.3000/0.1440 to 0.1490.

In the case where both bromine and iodine are used as the halogen atom, the ratio of the content (mol) of sulfur atom, phosphorus atom, bromine atom and iodine atom per the content (mol) of lithium atom is preferably lithium atom/sulfur atom/phosphorus atom/bromine atom/iodine atom=1/1.1000 to 1.2000/0.2000 to 0.3500/0.0700 to 0.0760/0.0700 to 0.0760, more preferably 1/1.1200 to 1.1800/0.2400 to 0.3200/0.0710 to 0.0755/0.0700 to 0.0755, even more preferably 1/1.1300 to 1.1700/0.2700 to 0.3000/0.0720 to 0.0750/0.0700 to 0.0750.

Falling within the range, a sulfide solid electrolyte having a thio-LISICON Region II-type crystal structure to be mentioned below and having a higher ionic conductivity can be readily produced.

Although the shape of the amorphous sulfide solid electrolyte is not particularly restricted, examples thereof include a granular shape. The average particle diameter (D₅₀) of the granular amorphous sulfide solid electrolyte is, for example, within a range of 0.01 μm to 500 μm, and 0.1 to 200 μm.

### (Crystalline Sulfide Solid Electrolyte

In the sulfide solid electrolyte of the present embodiment, the crystalline sulfide solid electrolyte may be a so-called glass ceramics which is obtained by heating the amorphous sulfide solid electrolyte to a crystallization temperature or higher. Examples of a crystal structure thereof include an Li₃PS₄ crystal structure, an Li₄P₂S₆ crystal structure, an Li₇PS₆ crystal structure, an Li₇P₃S₁₁ crystal structure, and a crystal structure having peaks at around 2θ=20.2° and 23.6° (see, for example, JP 2013-16423 A).

In the sulfide solid electrolyte of the present embodiment, the crystalline sulfide solid electrolyte preferably contains a thio-LISICON Region II-type crystal structure.

In addition, an Li₄₋ₓGe₁₋ₓPₓS₄-based thio-LISICON Region II-type crystal structure (see Kanno, et al., Journal of The Electrochemical Society, 148 (7) A742-746 (2001)) and a crystal structure similar to the Li₄₋ₓGe₁₋ₓPₓS₄-based thio-LISICON Region II-type crystal structure (see Solid State Ionics, 177 (2006), 2721-2725) and the like are also exemplified. The crystal structure of the crystalline sulfide solid electrolyte obtained according to the production method for a sulfide solid electrolyte of the present embodiment is preferably a thio-LISICON Region II-type crystal structure among those mentioned above, from the standpoint that a higher ionic conductivity is obtained.

Here, the “thio-LISICON Region II-type crystal structure” expresses any one of an Li₄₋ₓGe₁₋ₓPₓS₄-based thio-LISICON Region II-type crystal structure and a crystal structure similar to the Li₄₋ₓGe₁₋ₓPₓS₄-based thio-LISICON Region II-type crystal structure. In addition, though the crystalline sulfide solid electrolyte obtained by the production method of the present embodiment may be one having the aforementioned thio-LISICON Region II-type crystal structure or may be one having the thio-LISICON Region II-type crystal structure as a main crystal, it is preferably one having the thio-LISICON Region II-type crystal structure as a main crystal from the viewpoint of obtaining a higher ionic conductivity. In this specification, the wording “having as a main crystal” means that a proportion of the crystal structure serving as an object in the crystal structure is 80% or more, and it is preferably 90% or more, and more preferably 95% or more. In addition, from the viewpoint of obtaining a higher ionic conductivity, the crystalline sulfide solid electrolyte obtained by the production method of the present embodiment is preferably one not containing crystalline Li₃PS₄ (B—Li₃PS₄).

In the X-ray diffractometry using a CuKa ray, the Li₃PS₄ crystal structure gives diffraction peaks, for example, at around 2θ=17.5°, 18.3°, 26.1°, 27.3°, and 30.0°; the Li₄P₂S₆ crystal structure gives diffraction peaks, for example, at around 2θ=16.9°, 27.1°, and 32.5°; the Li₇PS₆ crystal structure gives diffraction peaks, for example, at around 2θ=15.3°, 25.2°, 29.6°, and 31.0°; the Li₇P₃S₁₁ crystal structure gives diffraction peaks, for example, at around 2θ=17.8°, 18.5°, 19.7°, 21.8°, 23.7°, 25.9°, 29.6°, and 30.0°; the Li₄₋ₓGe₁₋ₓPₓS₄-based thio-LISICON Region II-type crystal structure gives diffraction peaks, for example, at around 2θ=20.1°, 23.9°, and 29.5°; and the crystal structure similar to the Li₄₋ₓGe₁₋ₓPₓS₄-based thio-LISICON Region II-type crystal structure gives diffraction peaks, for example, at around 2θ=20.2 and 23.6°. The position of these peaks may vary within a range of ±0.5°.

As mentioned above, in the case when the thio-LISICON Region II-type crystal structure is obtained in the present embodiment, preferably, this does not contain a crystalline Li₃PS₄ (B—Li₃PS₄).

The sulfide solid electrolyte of the present embodiment does not have diffraction peaks at 2θ=17.5°, 26.1° as seen in crystalline Li₃PS₄, or even when having them, the detected peaks are extremely small as compared with the diffraction peaks of the thio-LISICON Region II-type crystal structure.

The crystal structure having the above-mentioned Li₇PS₆ skeletal structure in which a part of P is substituted with Si to have a compositional formula Li₇₋ₓP_{1-y}Si_{y}S₆ or Li₇₊ₓP_{1-y}Si_{y}S₆ (x represents −0.6 to 0.6, y represents 0.1 to 0.6) is a cubic crystal or a rhombic crystal, preferably a cubic crystal having peaks mainly appearing at the position of 2θ=15.5°, 18.0°, 25.0°, 30.0°, 31.4°, 45.3°, 47.0°, and 52.0° in X-ray diffractometry using a CuKα ray. The crystal structure shown by the above-mentioned compositional formula Li_{7-x-2y}PS_{6.x-y}Clₓ (0.8≤x≤1.7, 0<y≤−0.25x+0.5) is preferably a cubic crystal or a rhombic crystal having peaks mainly appearing at the position of 2θ=15.5°, 18.0°, 25.0°, 30.0°, 31.4°, 45.3°, 47.0°, and 52.0° in X-ray diffractometry using a CuKα ray. The crystal structure shown by the above-mentioned compositional formula Li₇₋ₓPS₆₋ₓHaₓ (Ha represents Cl or Br, x is preferably 0.2 to 1.8) is preferably a cubic crystal having peaks mainly appearing at the position of 2θ=15.5°, 18.0°, 25.0°, 30.0°, 31.4°, 45.3°, 47.0°, and 52.0° in X-ray diffractometry using a CuKα ray.

The position of these peaks may vary within a range of ±0.5°.

In the crystalline sulfide solid electrolyte of the sulfide solid electrolyte of the present embodiment, the content of lithium atom, sulfur atom, phosphorus atom and halogen atom is the same as that in the above-mentioned amorphous sulfide solid electrolyte.

Although the shape of the crystalline sulfide solid electrolyte is not particularly restricted, examples thereof include a granular shape. The average particle diameter (D₅₀) of the granular crystalline sulfide solid electrolyte is, for example, within a range of 0.01 μm to 500 μm, and 0.1 to 200 μm.

The crystallite diameter of the sulfide solid electrolyte of the present embodiment is preferably 30 nm or more. From the viewpoint of improving ionic conductivity and waterproofness, it is preferably 33 nm or more, more preferably 35 nm or more, even more preferably 40 nm or more, further more preferably 70 nm or more, and further more excellently preferably 80 nm or more. By crystallizing after the step (A), as mentioned below, the crystallite diameter of the sulfide solid electrolyte can be further increased, and in such a case, the crystallite diameter is still further more excellently preferably 90 nm or more. The upper limit is not specifically limited, but from ease of production, ease of preparation, and ease of production of batteries, the upper limit is preferably 300 nm or less, more preferably 250 nm or less, even more preferably 200 nm or less, further more preferably 150 nm or less, and further more excellently preferably 130 nm or less.

The ionic conductivity of the sulfide solid electrolyte of the present embodiment produced according to the production method of the present embodiment is extremely high as the PS₄³⁻ phosphorus ratio is high, and can be generally 0.01 mS/cm or more. The ionic conductivity is preferably 1.00 mS/cm or more, more preferably 2.00 mS/cm or more, even more preferably 2.50 mS/cm or more, further more preferably 3.00 mS/cm or more, and especially more preferably 3.50 mS/cm or more.

### <Raw Material Inclusion>

The production method for a sulfide solid electrolyte of the present embodiment needs mixing a raw material inclusion containing at least two raw materials.

The raw material inclusion contains at least two raw materials, and the raw material needs to contain at least one selected from a lithium atom, a sulfur atom, a phosphorus atom and a halogen atom, and further the raw material inclusion needs to contain modified P₂S₅ to be mentioned below.

As the raw materials contained in the raw material inclusion, employable is a compound containing at least one of a lithium atom, a sulfur atom, a phosphorus atom and a halogen atom. More specifically, representative examples include raw materials composed of at least two atoms selected from the aforementioned four kinds of atoms, such as lithium sulfide; lithium halides, e.g., lithium fluoride, lithium chloride, lithium bromide, and lithium iodide; phosphorus sulfides, e.g., diphosphorus trisulfide (P₂S₃) and diphosphorus pentasulfide (P₂S₅); phosphorus halides, e.g., various phosphorus fluorides (e.g., PF₃ and PF₅), various phosphorus chlorides (e.g., PCl₃, PCl₅, and P₂Cl₄), various phosphorus bromides (e.g., PBr₃ and PBr₅), and various phosphorus iodides (e.g., PI₃ and P₂I₄); solid electrolytes such as amorphous Li₃PS₄ or crystalline Li₃PS₄ having a PS₄ structure as a molecular structure, obtained from lithium sulfide and phosphorus sulfide; and thiophosphoryl halides, e.g., thiophosphoryl fluoride (PSF₃), thiophosphoryl chloride (PSCl₃), thiophosphoryl bromide (PSBr₃), thiophosphoryl iodide (PSI₃), thiophosphoryl dichlorofluoride (PSCl₂F), and thiophosphoryl dibromofluoride (PSBr₂F); and halogen simple substances, such as fluorine (F₂), chlorine (Cl₂), bromine (Br₂), and iodine (I₂), with chlorine (Cl₂), bromine (Br₂) and iodine (I₂) being preferred, and bromine (Br₂) and iodine (I₂) being more preferred.

More preferably, the raw material inclusion contains at least one selected from lithium sulfide, lithium halide, phosphorus sulfide, phosphorus halide and halogen molecule.

The case of the present embodiment using at least one selected from lithium sulfide, lithium halide, phosphorus sulfide, phosphorus halide and halogen molecule is preferred since a solid electrolyte having a high ionic conductivity can be obtained. It is also preferred to use a lithium halide for halogen introduction into the solid electrolyte along with a complexing agent and a solvent, since in the subsequent step for solvent removal, halogen atom separation does not occur and a solid electrolyte having a high ionic conductivity can be obtained.

Examples that can be used as the raw material inclusion other than those mentioned above include a raw material containing at least one atom selected from the above-mentioned four kinds of atoms, and containing any other atom than those four kinds of atoms, more specifically, lithium compounds, such as lithium oxide, lithium hydroxide, and lithium carbonate; alkali metal sulfides, such as sodium sulfide, potassium sulfide, rubidium sulfide, and cesium sulfide; metal sulfides, such as silicon sulfide, germanium sulfide, boron sulfide, gallium sulfide, tin sulfide (SnS, SnS₂), aluminum sulfide, and zinc sulfide; phosphate compounds, such as sodium phosphate and lithium phosphate; halide compounds with an alkali metal other than lithium, such as sodium halides, e.g., sodium iodide, sodium fluoride, sodium chloride, and sodium bromide; metal halides, such as an aluminum halide, a silicon halide, a germanium halide, an arsenic halide, a selenium halide, a tin halogen, an antimony halide, a tellurium halide, and a bismuth halide; and phosphorus oxyhalides, such as phosphorus oxychloride (POCl₃) and phosphorus oxybromide (POBr₃).

In the present embodiment, from the viewpoint of more easily obtaining a solid electrolyte having a high ionic conductivity, the raw material inclusion preferably contains, among those mentioned above, any of lithium sulfide, phosphorus sulfide, e.g., diphosphorus trisulfide (P₂S₃) and diphosphorus pentasulfide (P₂S₅), halogen simple substance (halogen molecule) such as fluorine (F₂), chlorine (Cl₂), bromine (Br₂), and iodine (I₂), and lithium halide such as lithium fluoride, lithium chloride, lithium bromide and lithium iodide. Examples of a preferred combination of raw materials include a combination of lithium sulfide, diphosphorus pentasulfide and lithium halide, and a combination of lithium sulfide, diphosphorus pentasulfide and halogen simple substance. As the lithium halide, preferred are lithium bromide and lithium iodide, and as the halogen simple substance, preferred are bromine and iodine.

The raw material inclusion in the present embodiment needs to contain modified P₂S₅, as mentioned above, and preferably contains modified P₂S₅, lithium sulfide and lithium halide, and the lithium halide preferably contains one or both of lithium bromide and lithium iodide. Namely, the raw material inclusion preferably contains modified P₂S₅, lithium sulfide, and as lithium halide, one or both of lithium bromide and lithium iodide.

The lithium sulfide which is used in the present embodiment is preferably a particle.

An average particle diameter (D₅₀) of the lithium sulfide particle is preferably 10 μm or more and 2,000 μm or less, more preferably 30 μm or more and 1,500 μm or less, and still more preferably 50 μm or more and 1,000 μm or less. In this specification, the average particle diameter (D₅₀) is a particle diameter to reach 50% of all the particles in sequential cumulation from the smallest particles in drawing the particle diameter distribution cumulative curve, and the volume distribution is concerned with an average particle diameter which can be, for example, measured with a laser diffraction/scattering particle diameter distribution measuring device. In addition, among the above-exemplified raw materials, the solid raw material is preferably a material having an average particle diameter of the same degree as that of the aforementioned lithium sulfide particle, namely a material having an average particle diameter falling within the same range as that of the aforementioned lithium sulfide particle is preferred.

<Modified P₂S₅>

Preferably, modified P₂S₅ is provided with an organic group.

As described above, modified P₂S₅ provided with an organic group is preferred. This is because when the sulfide solid electrolyte is brought into contact with moisture, generation of a hydrogen sulfide gas can be suppressed.

In the modified P₂S₅, the content of the organic group is preferably 0.005 mol or more relative to 1 mol of the phosphorus atom in the modified P₂S₅ for improving waterproofness of the resultant sulfide solid electrolyte. More preferably the content is 0.01 mol or more, even more preferably 0.03 mol or more, and for preventing reduction in the ionic conductivity of the sulfide solid electrolyte, the content is preferably 0.50 mol or less, more preferably 0.30 mol or less, even more preferably 0.20 mol or less, further more preferably 0.15 mol or less.

The value of a ratio of the modifying agent (mol) to the phosphorus atom (mol) in the modified P₂S₅ (modifying agent/P) can be presumed from the amount (mol) of the modifying agent used in producing modified P₂S₅ and the amount of P₂S₅ used.

The modifying agent is a chemical agent to be used for introducing an organic group in P₂S₅ as mentioned below.

The organic group containing a hetero atom can firmly interact with P₂S₅ as mentioned above, and the case is preferred since the organic group can be prevented from dropping off to reduce in the production process for the sulfide solid electrolyte and, in addition, even in the resultant sulfide solid electrolyte, the organic group can also be prevented from reducing.

The modified P₂S₅ is preferred since, in the modified P₂S₅, the phosphorus atom of P₂S₅ and the hetero atom can bond via a covalent bond to prevent the organic group from easily dropping off from the modified P₂S₅. This also bonds firmly to the sulfide solid electrolyte, and is therefore preferred.

The case where the hetero atom is at least one selected from a sulfur atom, an oxygen atom and a nitrogen atom and where “provided with” is a chemical bond is preferred since the hetero atom of the type can readily form a chemical bond, and the case where “provided with” is physical adsorption or a coordinate bond is also preferred since the atom has non-covalent electron pairs and therefore has large intermolecular force, or can form a coordinate bond with lithium atoms.

The organic group, at least one selected from the groups represented by the general formulae (a-1), (a-2) and (b-1) can firmly interact with P₂S₅ and therefore the organic group can be prevented from dropping off to reduce in the production process for the sulfide solid electrolyte, and in addition, can also be prevented from reducing in the resultant sulfide solid electrolyte. Consequently, the organic group of the type is preferred.

The sulfide solid electrolyte containing at least one selected from the groups represented by the general formulae (a-1), (a-2) and (b-1) is compared with other sulfide solid electrolyte not containing them. The former is preferred since, though containing the groups, reduction in the ionic conductivity can be suppressed, and even when brought into contact with moisture, generation of a hydrogen sulfide gas can also be suppressed. The organic group is more preferably a group represented by the general formula (a-1) or (b-1), and the group represented by the general formula (a-1) is even more preferred since reduction in the ionic conductivity can be suppressed. The group represented by the general formula (b-1) is even more preferred since generation of a hydrogen sulfide gas can be suppressed.

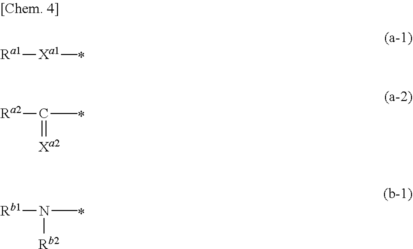

In the general formulae (a-1) and (a-2), preferably, Rₐ₁ and R^{a2} each are independently an alkyl group having 1 to 30 carbon atoms or an alkenyl group having 2 to 30 carbon atoms, more preferably an alkyl group having 4 to 20 carbon atoms or an alkenyl group having 4 to 20 carbon atoms, even more preferably an alkyl group having 6 to 12 carbon atoms or an alkenyl group having 6 to 12 carbon atoms, further more preferably a linear alkyl group having 6 to 10 carbon atoms or a linear alkenyl group having 6 to 10 carbon atoms.

The hydrogen atom in the alkyl group and the alkenyl group can be substituted with at least one of a monovalent alicyclic group having 3 to 10 carbon atoms or a monovalent aromatic group having 6 to 10 carbon atoms. —CH₂— in the alkyl group and the alkenyl group can be substituted with at least one of a divalent alicyclic group having 3 to 10 carbon atoms or a divalent aromatic group having 6 to 10 carbon atoms.

In the group represented by the general formula (b-1), preferably, R^{b1} and R^{b2} each are independently an alkyl group having 1 to 30 carbon atoms or an alkenyl group having 2 to 30 carbon atoms, more preferably an alkyl group having 2 to 20 carbon atoms or an alkenyl group having 2 to 20 carbon atoms, even more preferably an alkyl group having 2 to 8 carbon atoms or an alkenyl group having 2 to 8 carbon atoms, further more preferably a linear alkyl group having 3 to 5 carbon atoms or a linear alkenyl group having 3 to 5 carbon atoms.

The hydrogen atom in the alkyl group and the alkenyl group can be substituted with at least one of a monovalent alicyclic group having 3 to 10 carbon atoms or a monovalent aromatic group having 6 to 10 carbon atoms. —CH₂— in the alkyl group and the alkenyl group can be substituted with at least one of a divalent alicyclic group having 3 to 10 carbon atoms or a divalent aromatic group having 6 to 10 carbon atoms.

Preferably, X^{a1} and X^{a2} each are a sulfur atom. The case is preferred since a sulfur atom is an atom that constitute the sulfide solid electrolyte and therefore provides little composition change in the resultant sulfide solid electrolyte. Even when the sulfide solid electrolyte contains an organic group having a sulfur atom, it can still maintain a similar crystal structure.

### Modifying Agent

The modifying agent in the present embodiment is a chemical agent to be used for introducing an organic group into P₂S₅.

Modified P₂S₅ is P₂S₅ provided with an organic group, and can be produced by mixing P₂S₅ and a modifying agent in the same manner above. Further as needed, this can be optionally dried, heated and ground.

The modifying agent is mixed with P₂S₅ alone, and differs from the complexing agent to be mixed with a halogen atom-containing compound as mentioned below.

The modifying agent is a chemical agent to be used for introducing an organic group into P₂S₅, for which any one can be employed that can be used for forming a covalent bond between the phosphorus atom in P₂S₅ and the hetero atom in the organic group. Preferably, the modifying agent has, in the structure thereof, at least one selected from the groups represented by the general formulae (a-1), (a-2) and (b-1).

More specifically, the modifying agent is preferably a compound represented by the formulae (A-1), (A-2) or (B-1), more preferably a compound represented by the formulae (A-1) or (B-1).

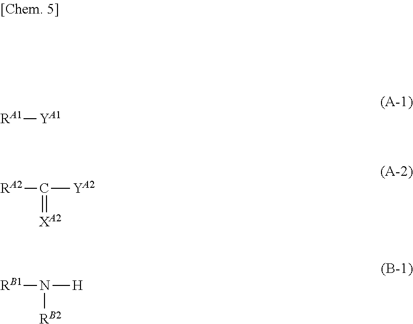

In the formulae R^{A1} has the same meaning as R^{a1}, R^{A2} has the same meaning as R^{a2}, R^{B1} has the same meaning as R^{b1}, R^{B1} has the same meaning as R^{b2}, X^{A2} has the same meaning as X^{a2}, Y^{A1} and Y^{A2} each independently represent a chlorine atom, a bromine atom, an iodine atom, a group —OH or a group —SH.

Preferably, R^{A1}, R^{A2}, R^{B1}, R^{B1} and X^{A2} each are the same group as that of the corresponding R^{a1}, R^{a2}, R^{b1}, R^{b2} and X^{a2}. Y^{A1} is preferably a group —OH or a group —SH, more preferably a group —SH. Y^{A2} is preferably a chlorine atom or a bromine atom, more preferably a chlorine atom.

More specifically, the modifying agent is preferably any of a thiol compound, a secondary amine compound and an alcohol compound.

In the case where suppression of ionic conductivity reduction of the sulfide solid electrolyte is emphasized, a thiol compound is preferred, where waterproofness is emphasized, a secondary amine compound is preferred, and where the balance between suppression of ionic conductivity reduction and waterproofness is emphasized, an alcohol compound is preferred.

The thiol compound is preferably one represented by the general formula (A-1) where Y^{A1} is —SH, R^{A1} is an alkyl group having 1 to 18 carbon atoms, more preferably an alkyl group having 4 to 12 carbon atoms, even more preferably an alkyl group having 6 to 10 carbon atoms, and further more preferably, the compound is 1-octanethiol.

The secondary amine compound is preferably one represented by the general formula (B-1) where R^{B1} and R^{B2} each are independently an alkyl group having 1 to 18 carbon atoms, more preferably an alkyl group having 2 to 8 carbon atoms, even more preferably an alkyl group having 3 to 6 carbon atoms, and further more preferably, the compound is n-dibutylamine.

The alcohol compound is preferably one represented by the general formula (A-1) where Y^{A1} is —OH, R^{A1} is an alkyl group having 1 to 18 carbon atoms, more preferably an alkyl group having 4 to 12 carbon atoms, even more preferably an alkyl group having 6 to 10 carbon atoms, and further more preferably, the compound is 1-octanol.

### Electrolyte Precursor

The production method for a sulfide solid electrolyte of the present embodiment is preferred, since in the method, the sulfide solid electrolyte can be produced by mixing via an electrolyte precursor, not requiring high temperatures.

The electrolyte precursor means a complexed precursor for a sulfide solid electrolyte.

The electrolyte precursor is composed of a complexing agent to be mentioned below, a lithium atom, a sulfur atom, a phosphorus atom, a halogen atom and an organic group, and is characterized in that it gives peaks different from peaks derived from raw materials in the X-ray diffraction pattern in X-ray diffractometry. This contains a complex crystal constituted of a complexing agent, a lithium atom, a sulfur atom, a phosphorus atom, a halogen atom and an organic group.

By merely mixing a raw material inclusion, the resultant mixture gives peaks derived from raw materials in the X-ray diffraction pattern, but by mixing a raw material inclusion and a complexing agent, peaks different from the raw materials-derived peaks are observed, and from this, it is known that the electrolyte precursor (complex crystal) has a structure obviously different from the raw materials themselves contained in the raw material inclusion.

The electrolyte precursor (complex crystal) is characterized by having a structure different from that of the crystalline solid electrolyte. This is also confirmed in the X-ray diffraction pattern.

The complex crystal is composed of a complexing agent, a lithium atom, a sulfur atom, a phosphorus atom, a halogen atom and an organic group, and typically it is presumed that a lithium atom bonds to other atom via a complexing agent and/or directly not via it to form a complex structure.

Here, the complexing agent that exists to constitute a complex crystal can be confirmed, for example, by gas chromatography analysis. Specifically, a powder of an electrolyte precursor is dissolved in methanol, and the resultant methanol solution was analyzed by gas chromatography to quantitatively determine the amount of the complexing agent contained in the complex crystal.

The content of the complexing agent in the electrolyte precursor varies depending on the molecular weight of the complexing agent, but is generally 10% by mass or more and 70% by mass or less or so, preferably 15% by mass or more and 65% by mass or less.

In the present embodiment, a halogen atom-containing complex crystal is preferably formed in point of ionic conductivity. Using a complexing agent, a lithium-containing structure such as a PS₄ structure bonds (by coordinating) to a lithium-containing raw material such as lithium halide via a complexing agent to readily give a complex crystal where halogen atoms are more highly dispersed and fixed, and the ionic conductivity is thereby increased.

The halogen atom in the electrolyte precursor constitutes a complex crystal, and this is confirmed by the fact that in solid-liquid separation of a slurry of the electrolyte precursor containing a complexing agent, a predetermined amount of a halogen atom is contained in the electrolyte precursor. This is because, the halogen atom not constituting a complex crystal can more readily dissolve out as compared with the halogen atom constituting a complex crystal, and is therefore discharged out in the solution in solid-liquid separation. In addition, it can also be confirmed in composition analysis by ICP analysis (inductivity coupled plasma optical emission spectrometry) of the electrolyte precursor or the solid electrolyte, in which the proportion of the halogen atom in the electrolyte precursor or the solid electrolyte does not remarkably lower as compared with the proportion of the halogen atom supplied by raw materials.

Preferably, the amount of the halogen atom to remain in the electrolyte precursor is 30% by mass or more of charged composition, more preferably 35% by mass or more, even more preferably 40% by mass or more. The upper limit of the amount of the halogen atom to remain in the electrolyte precursor is 100% by mass.

### <Complexing Agent>

The complexing agent is a substance capable of forming a complex with a lithium atom, and is meant to have a property of promoting formation of a complex crystal-containing electrolyte precursor by reacting with a lithium atom-containing sulfide or a halide contained in the raw material inclusion.

The modifying agent and the complexing agent can be the same compound, but differ in that the modifying agent preferably bonds via a covalent bond between the phosphorus atom of P₂S₅ in the modified P₂S₅ and the hetero atom, while the complexing agent forms a complex with a lithium atom. Since the modifying agent already has bonded to P₂S₅ and therefore does not contribute toward complex formation.

Using the complexing agent, the complex crystal-containing electrolyte precursor is formed, and hence a solid electrolyte having a high ionic conductivity can be obtained while suppressing dissolution of specific components such as halogen molecules that have caused conductivity reduction in conventional arts.

Any compound having the above-mentioned performance can be used as the complexing agent with no specific limitation, and preferred is a compound having an atom especially having a high affinity for a lithium atom, for example, a hetero atom such as a nitrogen atom, an oxygen atom and a chlorine atom, and more preferred is a compound having a group containing these hetero atoms. This is because these hetero atoms and the group containing the hetero atom can coordinate with (bond to) lithium.

The hetero atom existing in the molecule of the complexing agent has a high affinity for a lithium atom, and is considered to bond to the raw materials that contain a lithium atom and a halogen atoms such as a lithium-containing structure such as typically Li₃PS₄ containing a PS₄ structure of the main backbone of the sulfide solid electrolyte produced according to the production method of the present embodiment and a lithium halide, thereby readily forming an aggregate. Consequently, it is considered that, by mixing the raw material inclusion and the complexing agent, a lithium-containing structure such as a PS₄ structure or an aggregate via the complexing agent, a lithium-containing raw material such as lithium halide, or an aggregate via the complexing agent can exist thoroughly, and an electrolyte precursor where specific components such as halogen atoms have been more highly dispersed and fixed can be obtained, and as a result, a sulfide solid electrolyte having a high ionic conductivity can be obtained.

In addition, the case of the organic group is preferred since the organic group can be prevented from dissolving out from the modified P₂S₅ and the sulfide solid electrolyte, and the organic group can exist thoroughly in the sulfide solid electrolyte.

Consequently, the complexing agent preferably contains at least two hetero atoms each capable of forming a coordination site (bonding site) in the molecule, more preferably has a group containing at least two hetero atoms in the molecule. The complexing agent differs from the modifying agent in this point. A carbonyl group has two oxygen atoms in the structure, but the carbonyl group is considered to be one group.

Having a group containing at least two hetero atoms in the molecule, the complexing agent can bond a lithium-containing structure such as Li₃PS₄ containing a PS₄ structure, and a lithium-containing raw material such as a lithium halide via the two hetero atoms in the molecule, and therefore halogen atoms can be more highly dispersed and fixed in the electrolyte precursor. As a result, a solid electrolyte having a high ionic conductivity and capable of suppressing generation of a hydrogen sulfide gas can be obtained. Among the hetero atom, a nitrogen atom is preferred, and an amino group is preferred as the group containing a nitrogen atom. Namely, the complexing agent preferably contains an amino group-containing compound.

The amine compound having an amino group in the molecule can accelerate formation of the electrolyte precursor and is not specifically limited, but the complexing agent preferably contains a compound having at least two tertiary amino groups in the molecule.

Having such a structure, the compound can bond a lithium-containing structure such as Li₃PS₄ containing a PS₄ structure, and a lithium-containing raw material such as a lithium halide via the two nitrogen atoms in the molecule, and therefore halogen atoms can be more highly dispersed and fixed in the electrolyte precursor. As a result, a solid electrolyte having a high ionic conductivity can be obtained.

Examples of such amine compounds include amine compounds such as an aliphatic amine, an alicyclic amine, a heterocyclic amine and an aromatic amine, and one alone or plural kinds thereof can be used either singly or as combined.

More specifically, representative preferred examples of the aliphatic amine include an aliphatic diamine, such as an aliphatic primary diamine such as ethylenediamine, diaminopropane, and diaminobutane; an aliphatic secondary diamine such as N,N′-dimethylethylenediamine, N,N′-diethylethylenediamine, N,N′-dimethyldiaminoprop ane, and N,N′-diethyldiaminopropane; and an aliphatic tertiary diamine such as N,N,N′,N′-tetramethyldiaminomethane, N,N,N′,N′-tetramethylethylenediamine, N,N,N′,N′-tetraethylethylenediamine, N,N,N′,N′-tetramethyldiaminopropane, N,N,N′,N′-tetraethyldiaminopropane, N,N,N′,N′-tetramethyldiaminobutane, N,N,N′,N′-tetramethyldiaminpentane, and N,N,N′,N′-tetramethyldiaminohexane. Here, regarding exemplification in the present specification, for example, diaminobutane indicates, unless otherwise specifically noted, all isomers including isomers relating to the position of the amino group such as 1,2-diaminobutane, 1,3-diaminobutane and 1,4-diaminobutane, and in addition thereto, linear and branched isomers relating to butane.

The carbon number of the aliphatic amine is preferably 2 or more, more preferably 4 or more, even more preferably 6 or more, and the upper limit is 10 or less, more preferably 8 or less, even more preferably 7 or less. The carbon number of the hydrocarbon group of the aliphatic hydrocarbon group in the aliphatic amine is preferably 2 or more, and the upper limit is preferably 6 or less, more preferably 4 or less, even more preferably 3 or less.

Representative preferred examples of the alicyclic amine include an alicyclic diamine, such as an alicyclic primary diamine such as cyclopropanediamine, and cyclohexanediamine; an alicyclic secondary diamine such as bisaminomethylcyclohexane; and an alicyclic tertiary diamine such as N,N,N′,N′-tetramethyl-cyclohexanediamine, and bis(ethylmethylamino)cyclohexane. Representative preferred examples of the heterocyclic amine include a heterocyclic diamine, such as a heterocyclic primary diamine such as isophoronediamine; a heterocyclic secondary diamine such as piperazine, and dipiperidylpropane; and a heterocyclic tertiary diamine such as N,N-dimethylpiperazine, and bismethylpiperidylpropane.

The carbon number of the alicyclic amine and the heterocyclic amine is preferably 3 or more, more preferably 4 or more, and the upper limit is preferably 16 or less, more preferably 14 or less.

Representative preferred examples of the aromatic amine include an aromatic diamine, such as an aromatic primary diamine such as phenyldiamine, tolylenediamine and naphthalenediamine; an aromatic secondary diamine such as N-methylphenylenediamine, N,N′-dimethylphenylenediamine, N,N′-bismethylphenylphenylenediamine, N,N′-dimethylnaphthalenediamine, N-naphthylethylenediamine; and an aromatic tertiary diamine such as N,N-dimethylphenylenediamine, N,N,N′,N′-tetramethylphenylenediamine, N,N,N′,N′-tetramethyldiaminodiphenylmethane, and N,N,N′,N′-tetramethylnaphthalene diamine.

The carbon number of the aromatic amine is preferably 6 or more, more preferably 7 or more, even more preferably 8 or more, and the upper limit is preferably 16 or less, more preferably 14 or less, even more preferably 12 or less.

The amine compound for use in the present embodiment can be substituted with a substituent such as an alkyl group, an alkenyl group, an alkoxy group, a hydroxy group or a cyano group, or a halogen atom.

Diamine are exemplified as specific examples, but needless-to-say, the amine compound for use in the present embodiment is not limited to diamines. For example, employable here are monoamines, such as trimethylamine, triethylamine, ethyldimethylamine, and aliphatic monoamines corresponding to various diamines such as the above-mentioned aliphatic diamines; as well as piperidine compounds such as piperidine, methylpiperidine and tetramethylpiperidine; pyridine compounds such as pyridine and picoline, morpholine compounds such as morpholine, methylmorpholine, and thiomorpholine; imidazole compounds such as imidazole and methylimidazole; alicyclic monoamines such as monoamines corresponding to the above-mentioned alicyclic diamines; heterocyclic monoamines corresponding to the above-mentioned heterocyclic diamines; and monoamines such as aromatic monoamines corresponding to the above-mentioned aromatic diamines, and also polyamines having 3 or more amino groups such as diethylenetriamine, N,N′,N″-trimethyldiethylenetriamine, N,N,N′,N″,N″-pentamethyldiethylenetriamine, triethylenetetramine, N,N′-bis [(dimethylamino)ethyl]-N,N′-dimethylethylenediamine, hexamethylenetetramine, and tetraethylenepentamine.

Among the above, from the viewpoint of attaining a higher ionic conductivity, preferred is a tertiary amine having a tertiary amino group as the amino group, more preferred is a tertiary diamine having two tertiary amino groups, even more preferred is a tertiary diamine having two tertiary amino groups at both ends, and further more preferred is an aliphatic tertiary diamine having tertiary amino groups at both ends. Of the above-mentioned amine compounds, as the aliphatic tertiary diamine having tertiary amino groups at both ends, preferred are tetramethylethylenediamine, tetraethylethylenediamine, etramethyldiaminopropane and tetraethyldiaminopropane, and in consideration of easy availability, preferred are tetramethylethylenediamine and tetramethyldiaminopropane.

Examples of other complexing agents than amine compounds include compounds having a group containing a hetero atom such as an oxygen atom or a halogen atoms such as a chlorine atom, and these compounds have a high affinity with lithium atom and are examples of other complexing agents than amine compounds. Compounds having other group than an amino group, containing a nitrogen atom as a hetero atom, for example, those having a group such as a nitro group or an amide group can also provide the same effects as above.

Examples of the other complexing agent include alcohol solvents such as ethanol and butanol; ester solvents such as ethyl acetate and butyl acetate; aldehyde solvents such as formaldehyde, acetaldehyde and dimethylformamide; ketone solvents such as acetone, methyl ethyl ketone and cyclohexanone; ether solvents such as diethyl ether, diisopropyl ether, dibutyl ether, tetrahydrofuran, dimethoxyethane, diethoxyethane, cyclopentyl methyl ether, tert-butyl methyl ether, and anisole; glycol ester solvents such as 2-methoxyethyl acetate, 2-ethoxyethyl acetate (ethylene glycol acetate), 2-methoxy-1-methylethyl acetate, 2-ethoxy-methylethyl acetate, 2-(2 -ethoxyethoxy)ethyl acetate, (2-acetoxyethoxy)methyl acetate, 1-methyl-2-ethoxyethyl acetate (propylene glycol monoethyl ether acetate), ethyl 3-methoxypropionate, ethyl 3-ethoxypropionate, and 2-methoxyethyl 3-(2-methoxyethoxy)propionate; halogen atom-containing aromatic hydrocarbon solvents such as trifluoromethylbenzene, nitrobenzene, chlorobenzene, chlorotoluene, and bromobenzene; and solvents containing a carbon atom and a hetero atom, such as acetonitrile, dimethyl sulfoxide and carbon disulfide. Among these, ether solvents and glycol ester solvents are preferred, and glycol ester solvents are more preferred. Among ether solvents, diethyl ether, diisopropyl ether, dibutyl ether and tetrahydrofuran are preferred, and diethyl ether, diisopropyl ether and dibutyl ether are more preferred. Among glycol ester solvents, acetates are more preferred, and 2-methoxy-1-methylethyl acetate and 2-ethoxy-methylethyl acetate are even more preferred.

The amount of the complexing agent to be used per gram of the total mass of the raw material inclusion is, from the viewpoint of efficiently attaining the use effect of the complexing agent that forms an electrolyte precursor with halogen atoms more highly dispersed therein to thereby give a solid electrolyte having a high ionic conductivity, preferably 0.1 to 30 mL, more preferably 0.5 to 20 mL, even more preferably 1.0 to 10 mL.

### <Solvent>

In the present embodiment, a solvent is preferably added in “mixing” or “grinding”. By mixing the raw material inclusion and the complexing agent using a solvent, the effect of using the complexing agent, that is, the effect of accelerating formation of the electrolyte precursor in reacting with a lithium atom, a sulfur atom, a phosphorus atom and a halogen atom can be more surely attained, precisely the effect of making a lithium-containing structure such as a PS₄ structure or an aggregate via a complexing agent, or also an aggregate via a lithium-containing raw material such as lithium halide or a complexing agent readily exist thoroughly to give an electrolyte precursor with halogen atoms more highly dispersed and fixed therein so as to secure, as a result, a high ionic conductivity can be more surely attained.

The present embodiment is a so-called heterogeneous method, in which preferably the electrolyte precursor does not completely dissolve in the solvent or the complexing agent that is liquid but can precipitate. In the present embodiment, by adding a solvent, electrolyte precursor dissolution can be controlled. In particular, halogen atoms readily dissolve out from the electrolyte precursor, and by adding a solvent, a desired electrolyte precursor can be obtained while dissolution of halogen atom is retarded. As a result, via an electrolyte precursor where components such as halogens are dispersed, a crystalline sulfide solid electrolyte having a high ionic conductivity can be obtained.

The solvent can be again put into a slurry of the electrolyte precursor after mixing.

The solvent having such properties is preferably a solvent having a solubility parameter of 10 or less. In the present specification, the solubility parameter is described in various documents, for example, “Chemical Handbook” (issued in 2004, revised 5th edition, Maruzen Corporation), and is a value δ ((cal/cm³)^{1/2}) calculated according to the following mathematical formula (1), and this is also referred to as a Hildebrand parameter, SP value.

[Math. 1]

δ=\sqrt{(ΔH−RT)/V} (1)

In the mathematical formula (1), ΔH is a molar heat generation, R is a vapor constant, T is a temperature, V is a molar volume.

By using a solvent having a solubility parameter of 10 or less, a halogen atom and the raw material inclusion containing a halogen atom such as lithium halide, and further a component containing a halogen atom that constitutes a complex crystal contained in the electrolyte precursor (for example, an aggregate of a lithium halide and the complexing agent bonding thereto) can be made to be hardly soluble, relatively as compared the above-mentioned modifying agent and the above-mentioned complexing agent, and therefore the above-mentioned organic group and halogen atoms can be readily fixed in the complex so that in the resultant modified P₂S₅ and electrolyte precursor and further in the sulfide solid electrolyte, the organic group and halogen atoms can exist in a well dispersed state, and a sulfide solid electrolyte having a high ionic conductivity and excellent waterproofness can be readily obtained. Specifically, it is desirable that the solvent for use in the present embodiment does not dissolve or hardly dissolves the modifying agent and the electrolyte precursor, and more preferably the solvent is one containing a solvent that does not dissolve the raw material inclusion, the modifying agent, the complexing agent and the electrolyte precursor.

From the same viewpoint, the solubility parameter of the solvent is preferably 9.5 or less, more preferably 9.0 or less, even more preferably 8.5 or less.

More specifically, a solvent heretofore widely used in solid electrolyte production can be employed as the solvent in the present embodiment. Examples thereof include a hydrocarbon solvent such as an aliphatic hydrocarbon solvent, an alicyclic hydrocarbon solvent and an aromatic hydrocarbon solvent; and an alcohol solvent, an ester solvent, an aldehyde solvent, a ketone solvent, an ether solvent, and a solvent containing a carbon atom, such as a solvent containing a carbon atom and a hetero atom. Among these, it is preferable that one whose solubility parameter falls within the above range is appropriately selected and used.

More specifically, the solvent includes an aliphatic hydrocarbon solvent such as hexane, pentane, 2-ethylhexane, heptane, octane, decane, undecane, dodecane, and tridecane; an alicyclic hydrocarbon solvent such as cyclohexane, methylcyclohexane, and ethylcyclohexane; an aromatic hydrocarbon solvent such as benzene, toluene, xylene, mesithylene, ethylbenzene, tert-butylbenzene, trifluoromethylbenzene, nitrobenzene, chlorobenzene, chlorotoluene, and bromobenzene; an alcohol solvent such as ethanol, and butanol; an ester solvent such as ethyl acetate and butyl acetate; an aldehyde solvent such as formaldehyde, acetaldehyde, and dimethylformamide; a ketone solvent such as acetone, and methyl ethyl ketone; an ether solvent such as diethyl ether, diisopropyl ether, dibutyl ether, tetrahydrofuran, dimethoxyethane, cyclopentyl methyl ether, tert-butyl methyl ether and anisole; and a solvent containing a carbon atom and a hetero atom such as acetonitrile, dimethyl sulfoxide, and carbon disulfide.

Among these solvents, preferred are an aliphatic hydrocarbon solvent, an alicyclic hydrocarbon solvent, an aromatic hydrocarbon solvent, and an ether solvent; and from the viewpoint of more stably attaining a high ionic conductivity, preferred are an aliphatic hydrocarbon solvent, an alicyclic hydrocarbon solvent and an aromatic hydrocarbon solvent, more preferred are heptane, cyclohexane, methylcyclohexane, ethylcyclohexane, dimethylcyclohexane, toluene and ethyl benzene, and even more preferred are heptane, cyclohexane, methylcyclohexane and ethylcyclohexane. The solvent for use in the present embodiment is preferably the organic solvent of the above-mentioned exemplifications and is an organic solvent differing from the above-mentioned complexing agent. In the present embodiment, one alone or plural kinds of these solvents can be used either singly or as combined.

The amount of the solvent to be used per gram of the total mass of the raw material inclusion is, from the viewpoint of obtaining a sulfide solid electrolyte having a high ionic conductivity and waterproofness, preferably 5 to 50 mL, more preferably 5 o 30 mL, even more preferably 5 to 20 mL.

[Modified P₂S₅ Provided with Organic Group, for Production of Sulfide Solid Electrolyte]

The modified P₂S₅ for production of a sulfide solid electrolyte of the present embodiment needs to be a modified P₂S₅ provided with an organic group for production of a sulfide solid electrolyte.

When the modified P₂S₅ provided with an organic group for production of a sulfide solid electrolyte is used in the production method for a sulfide solid electrolyte, a sulfide solid electrolyte having a high ionic conductivity and having excellent waterproofness can be produced.

As such, the modified P₂S₅ is as mentioned above.

### Use of Sulfide Solid Electrolyte

The sulfide solid electrolyte of the present embodiment has a high ionic conductivity and has excellent waterproofness, and is therefore favorably used for an electrode mixture for lithium ion batteries and for a lithium ion battery.

In the case of adopting a lithium element as the conduction species, such is especially suitable. The sulfide solid electrolyte of the present embodiment may be used for a positive electrode layer, may be used for a negative electrode layer, or may be used for an electrolyte layer.

The aforementioned battery preferably uses a collector in addition to the positive electrode layer, the electrolyte layer, and the negative electrode layer, and the collector can be any known one. For example, a layer formed by coating Au, Pt, Al, Ti, Cu, or the like capable of reacting with the aforementioned sulfide solid electrolyte, with Au or the like can be used.

### [Electrode Mixture]

The electrode mixture of the present embodiment needs to contain the above-mentioned sulfide solid electrolyte and an electrode active material to be mentioned below.

### Electrode Active Material

As the electrode active material, employed is any of a positive-electrode active material or a negative-electrode active material depending on the use of the electrode mixture as any of a positive electrode or a negative electrode.

With no specific limitation, as the positive-electrode active material, herein employable is any one capable of accelerating cell chemical reaction accompanied with transfer of an ion of an atom employed as an atom of expressing an ionic conductivity in relation to the negative-electrode active material, preferably a lithium ion caused by a lithium atom. The positive-electrode active material capable of enabling such lithium ion insertion and desorption includes an oxide-type positive-electrode active material and a sulfide-type positive-electrode active materials.

The oxide-type positive-electrode active material is preferably a lithium-containing transition metal composite oxide such as LMO (lithium manganate), LCO (lithium cobaltate), NMC (lithium nickel-manganese-cobaltate), NCA (lithium nickel-cobalt-aluminate), LNCO (lithium nickel-cobaltate), and an olivine-type compound (LiMeNPO₄, Me=Fe, Co, Ni, Mn).

The sulfide-type positive-electrode active material includes titanium sulfide (TiS₂), molybdenum sulfide (MoS₂), iron sulfide (FeS, FeS₂), copper sulfide (CuS), and nickel sulfide (Ni₃S₂).

In addition to the above-mentioned positive-electrode active material, niobium selenide (NbSe₃) is also employable.

One kind alone or plural kinds of positive-electrode active materials can be used either singly or as combined.

With no specific limitation, as the negative-electrode active material, employable is any one capable of accelerating cell chemical reaction accompanied with transfer of an ion of an atom employed as an atom of expressing an ionic conductivity, preferably a lithium ion caused by a lithium atom, such as a metal capable of forming an alloy with a lithium atom, an oxide thereof, or an alloy of the metal with a lithium atom. As the negative-electrode active material capable of enabling such lithium ion insertion and desorption of the type, any one known as a negative-electrode active material in the battery field can be used with no specific limitation.

Examples of the negative electrode-active material include a metal lithium or a metal capable of forming an alloy with a metal lithium, such as a metal lithium, a metal indium, a metal aluminum, a metal silicon and a metal tin, an oxide of these metals, or an alloy of these metals and a metal lithium.

The electrode active material for use in the present embodiment may be one whose surface is coated, that is, one having a coating layer.

The material to form the coating layer includes an ion conductor, such as a nitride, an oxide or a composite thereof of an atom capable of expressing an ionic conductivity in a sulfide solid electrolyte, preferably a lithium atom. Specifically, it includes lithium nitride (Li₃N), a LISICON-type crystal structure-having conductor having a main structure of Li₄GeO₄, for example, Li₄₋₂ₓZnₓGeO₄; a thio-LISICON-type crystal structure-having conductor having a backbone structure of Li₃PO₄, for example, Li₄₋ₓGe₁₋ₓPₓS₄; a perovskite crystal structure-having conductor such as La_{2/3-x}Li₃ₓTiO₃; and a NASICON-type crystal structure-having conductor such as LiTi₂(PO₄)₃.

Also the material includes lithium titanate such as Li_{y}Ti_{3-y}O₄ (0<y<3), Li₄Ti₅O₁₂ (LTO); a lithium metallate with a metal belonging to the Group 5 of the Periodic Table, such as LiNbO₃, and LiTaO₃; and an oxide-type conductor such as Li₂O—B₂O₃—P₂O₅, Li₂O—B₂O₃—ZnO, and Li₂O—Al₂O₃—SiO₂—P₂O₅—TiO₂ conductors.

The electrode active material coated with a coating layer can be obtained, for example, by adhering a solution that contains various atoms constituting the material to form the coating layer onto the surface of the electrode active material, and firing the solution-adhering electrode active material preferably at 200° C. or higher and 400° C. or lower.

Here, as the solution containing various atoms, employable is a solution containing an alkoxide of various metals such as lithium ethoxide, titanium isopropoxide, niobium isopropoxide and tantalum isopropoxide. The solvent usable in that case includes an alcohol solvent such as ethanol and butanol; an aliphatic hydrocarbon solvent such as hexane, heptane and octane; and an aromatic hydrocarbon solvent such as benzene, toluene and xylene.

The adhesion can be performed by immersion or spray-coating.

The firing temperature is, from the viewpoint of improving production efficiency and battery performance, preferably 200° C. or higher and 400° C. or lower as mentioned above, more preferably 250° C. or more and 390° C. or lower, and the firing time can be generally 1 minute to 10 hours or so, preferably 10 minutes to 4 hours.

The coating ratio with the coating layer is, based on the surface area of the electrode active material, preferably 90% or more, more preferably 95% or more, even more preferably 100%, that is, the entire surface is preferably coated. The thickness of the coating layer is preferably 1 nm or more, more preferably 2 nm or more, and the upper limit is preferably 30 nm or less, more preferably 25 nm or less.

The thickness of the coating layer can be measured in observation of the cross section with a transmission electronic microscope (TEM), and the coating ratio can be calculated from the thickness of the coating layer, the elementary analysis data and the BET specific surface area.

### Other Components

The electrode mixture of the present embodiment can contain any other component such as a conductive material and a binder, in addition to the above-mentioned sulfide solid electrolyte and electrode active material. Namely, in the production method for the electrode mixture of the present embodiment, any other component such as a conductive material and a binder can be used, in addition to the above-mentioned sulfide solid electrolyte and electrode active material. The other component such as a conductive material and a binder can be mixed with the above-mentioned sulfide solid electrolyte and electrode active material by further adding it to the sulfide solid electrolyte and the electrode active material.

The conductive material includes, from the viewpoint of improving electron conductivity to thereby improve battery performance, carbonaceous materials such as artificial graphite, graphite carbon fiber, resin baked carbon, thermally-decomposed vapor-grown carbon, coke, mesocarbon microbead, furfuryl alcohol resin baked carbon, polyacene, pitch carbon fiber, vapor-grown carbon fiber, natural graphite, and hardly graphitizable carbon.

Using a binder, the strength of positive electrodes and negative electrodes to be produced can increase.

The binder is not specifically limited so far as it can impart functions such as binding performance and flexibility and examples thereof include a fluorine-based polymer such as polytetrafluoroethylene and polyvinylidene fluoride; a thermoplastic elastomer such as butylene rubber and styrene-butadiene rubber; and various resins such as acrylic resin, acrylic polyol resin, polyvinyl acetal resin, polyvinyl butyral resin and silicone resin.

The blending ratio (by mass) of the electrode active material to the sulfide solid electrolyte in the electrode mixture is, for improving the battery performance and in consideration of production efficiency, preferably 99.5/0.5 to 40/60, more preferably 99/1 to 50/50, even more preferably 98/2 to 60/40.

In the case where a conductive material is contained, the content of the conductive material in the electrode mixture is not specifically limited but is, for improving the battery performance and in consideration of production efficiency, preferably 0.5% by mass or more, more preferably 1% by mass or more, even more preferably 1.5% by mass or more, and the upper limit is preferably 10% by mass or less, preferably 8% by mass or less, even more preferably 5% by mass or less.

In the case where a binder is contained, the content of the binder in the electrode mixture is not specifically limited but is, for improving the battery performance and in consideration of production efficiency, preferably 1% by mass or more, more preferably 3% by mass or more, even more preferably 5% by mass or more, and the upper limit is preferably 20% by mass or less, preferably 15% by mass or less, even more preferably 10% by mass or less.

### [Lithium Ion Battery]

The lithium ion battery of the present embodiment needs to contain at least one selected from the above-mentioned sulfide solid electrolyte of the present embodiment and the above-mentioned electrode mixture.

The lithium ion battery of the present embodiment is not specifically limited in point of the structure thereof so far as it contains any of the above-mentioned sulfide solid electrolyte of the present embodiment and the electrode mixture containing it, and the lithium ion battery of the present embodiment can have a structure of general-purpose lithium ion batteries.

Preferably, the lithium ion battery of the present embodiment is provided with, for example, a positive electrode layer, a negative electrode layer, an electrolyte layer and a collector. Preferably, for the positive electrode layer and the negative electrode layer, the electrode mixture of the present embodiment is used, and also preferably, for the electrolyte layer, the sulfide solid electrolyte of the present embodiment is used.

As the collector, any known one is usable. For example, a layer formed by coating one capable of reacting with the above-mentioned solid electrolyte, such as Au, Pt, Al, Ti or Cu, with Au or the like can be used.

### EXAMPLES

Next, the present invention is described specifically with reference to Examples, but it should be construed that the present invention is by no means restricted by these Examples.

### (1) Measurement Method

### (1-1) Measurement of Ionic Conductivity

In the present Examples, the ionic conductivity was measured as follows.

A sulfide solid electrolyte was molded into disc pellets having a diameter of 10 mm (cross section S: 0.785 cm²) and a height (L) of 0.1 to 0.3 cm to be samples. An electrode terminal was taken from the top and the bottom of the sample, and in measurement according to an AC impedance method at 25° C. (frequency range: 1 MHz to 100 Hz, amplitude: 10 mV), Cole-Cole plots were drawn. At around the right edge of the arc observed in the high-frequency region, the real part Z′ (Ω) at the point at which -Z″ (Ω) is the smallest is referred to as a bulk resistance R (Ω) of the electrolyte, and according to the following mathematical formulae, the ionic conductivity σ (S/cm) was calculated.

R=ρ(L/S)

σ=1/ρ

### (1-2) Waterproofness Evaluation (H₂S Generation Amount)

The exposure test apparatus (FIG. 2) includes, as main constituent elements, a flask 10 for wetting nitrogen, a static mixer 20 for mixing wetted nitrogen and unwetted nitrogen, a dew point recorder 30 (M170/DMT152, by VAISALA Corporation) for measuring moisture in the mixed nitrogen, a double tube reactor 40 for setting a measurement sample therein, a dew point recorder 50 for measuring moisture in the nitrogen discharged out from the double tube reactor 40, and a sulfide hydrogen recorder 60 (Model 3000RS, by AMI Corporation) for measuring the hydrogen sulfide concentration in the discharged nitrogen, and these are connected via tubes (not shown) to constitute the apparatus. The temperature in the flask 10 is set at 10° C. by a cooling tank 11.

As the tube for connecting the constituent elements, a Teflon (registered trademark) tube having a diameter of 6 mm was used. In FIG. 2, expression of the tube was omitted, and in place of it, nitrogen flows are expressed as arrows.

The evaluation process is as follows.

In a nitrogen glove box in which the dew point was set at −80° C., about 0.15 g of a powdery sample 41 was weighed, and sealed up inside the tube reactor 40 as sandwiched between quarts wool 42.

From a nitrogen source (not shown), 0.02 MPa nitrogen was introduced into the apparatus 1. The applied nitrogen passes through the dichotomous branching pipe BP, and a part thereof is supplied to the flask 10 and wetted therein. The other is directly supplied to the static mixer 20 as unwetted nitrogen. The supply amount of nitrogen into the flask 10 was controlled by the needle valve V.

The dew point was controlled by controlling the flow rate of the unwetted nitrogen and the wetted nitrogen by a mass flow controller/mass flow meter (MODEL 8500, by KOFLOC Corporation) FM. Specifically, at a flow rate of the unwetted nitrogen 750 to 800 mL/min and at a flow rate of the wetted nitrogen 30 to 90 mL/min, the two were supplied to the static mixer 20 and mixed therein, and the dew point of the mixed gas (mixture of unwetted nitrogen and wetted nitrogen) was confirmed with the dew point recorder 30.

After the dew point was controlled at −20° C., the three-way cock was rotated and the mixed gas was distributed through the inside of the tube reactor 40 for 2 hours. The amount of hydrogen sulfide contained in the mixed gas that had passed through the sample 41 was measured with the hydrogen sulfide meter 60. The hydrogen sulfide amount generated during this was determined per gram of the sample (unit: cc/g). After the measurement, the gas was made to pass through the alkali trap 70 for removing hydrogen sulfide.

After the sample was exposed for a determined period of time, supply of wetted nitrogen was stopped, and the tube reactor 40 was sealed up with unwetted nitrogen.

### (1-3) Average Particle Diameter (D₅₀)

A volume-based average particle diameter (D₅₀) was measured with a laser diffraction/scattering particle size distribution measuring apparatus (“Partica LA-950 V2 Model LA-950W2”, by HORIBA, Ltd.). A mixture prepared by mixing dewatered toluene (by FUJIFILM Wako Pure Chemical Corporation, special grade chemical) and tertiary butyl alcohol (by FUJIFILM Wako Pure Chemical Corporation, special grade chemical) in a ratio by weight 93.8/6.2 was used as a dispersion medium. 50 mL of the dispersion medium was injected into a flow cell of the apparatus and circulated therein, and then a subject to be analyzed is added and ultrasonically processed, and thereafter the particle size distribution thereof was measured. The amount of the subject to be analyzed was so controlled that, on the screen for measurement as defined by the apparatus, the red light transmittance (R) corresponding to the particle concentration could fall 90 to 90% and the blue light transmittance (B) could fall 70 to 90%. Regarding the arithmetic condition, the refractive index of the subject to be analyzed is 2.16, and the refractive index of the dispersion medium is 1.49. In setting the distribution morphology, the number of repetition was fixed at 15 times in particle size calculation.

### (1-4) Induction Coupled Plasma (ICP) Emission Spectrophotometer (Determination of Composition)

A powder of the sulfide solid electrolyte was weighed and, in an argon atmosphere, collected in a vial bottle. An alkaline aqueous KOH solution was put into the vial bottle, and the sample therein was dissolved with taking care in capturing sulfur. After appropriately diluted, this is referred to a measurement solution. The resultant measurement solution was analyzed with a Paschen-Runge ICP-OES apparatus (SPECTRO ARCOS, by SPECTRO Corporation) to determine the composition.

Calibration curve solutions were prepared, using 1000 mg/L standard solution for ICP measurement, for Li, P and S; 1000 mg/L standard solution for ion chromatography for Br; and potassium iodide (special grade chemical reagent) for I.

Two measurement solutions were prepared individually for every sulfide solid electrolyte, and each measurement solution was analyzed for a total of 4 times. The resultant data were averaged to measure an average value. From the average of the measured values of the two measurement solutions, the composition was determined.

From the resultant element ratio, the content of the phosphorus atom, the sulfur atom and the halogen atom was calculated, each relative to the content of the lithium atom.

### (2) Production Example for Modified P₂S₅

In an inert gas atmosphere in a glove box, 5.0 g (22.5 mmol) of P₂S₅ was weighed in a Schlenk bottle having a stirring bar therein, and 50 mL of a solvent toluene was put thereinto. 67.2 mg of a modifying agent 1-octanethiol (0.0100 mol relative to 1 mol of the phosphorus atom in P₂S₅, corresponding to modifying agent/P in Table 1) was further put thereinto, and then stirred at 120° C. for 2 hours. The stirring was stopped, this was depressurized for 2 hours with a vacuum pump to dry the liquid toluene, thereby giving modified P₂S₅ (1).

In the same manner except that the modifying agent described in Table 1 was used at the ratio modifying agent/P described in Table 1, modified P₂S₅ (2) to (6) were obtained.

TABLE 1

| | Modifying Agent | Modifying Agent/P |
|---|---|---|
| Modified P₂S₅ (1) | 1-octanethiol | 0.0100 |
| Modified P₂S₅ (2) | 1-octanethiol | 0.0500 |
| Modified P₂S₅ (3) | 1-octanethiol | 0.1020 |
| Modified P₂S₅ (4) | 1-octanol | 0.0500 |
| Modified P₂S₅ (5) | n-dibutylamine | 0.0500 |
| Modified P₂S₅ (6) | n-dibutylamine | 0.1000 |

### Example 1

In an inert gas atmosphere in a glove box, 1.91 g of the above-mentioned modified P₂S₅ (1), 1.17 g of Li₂S, 0.369 g of LiBr and 0.569 g of LiI, as a raw material inclusion, were weighed in a Schlenk bottle having a stirring bar therein, and 8.9 mL of a complexing agent N,N,N′,N′-tetramethylethylenediamine (TMEDA) and 40 mL of a solvent cyclohexane were put thereinto. This was stirred for 3 days at room temperature not heated from the outside. The stirring was stopped, this was depressurized for 2 hours with a vacuum pump to dry the liquid TMEDA and cyclohexane, thereby giving a powdery electrolyte precursor (1).

The resultant electrolyte precursor (1) was heated at 110° C. for 2 hours to give an amorphous sulfide solid electrolyte (1).

Further the resultant amorphous sulfide solid electrolyte (1) was heated at 180° C. for 2 hours to give a crystalline sulfide solid electrolyte (1).

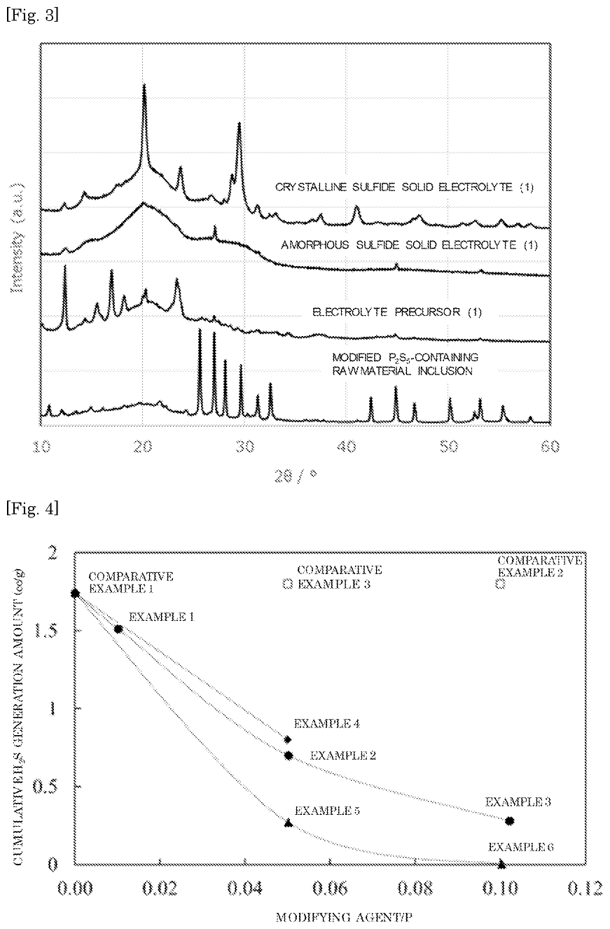

FIG. 3 shows XRD patterns of the raw material inclusion containing modified P₂S₅, the electrolyte precursor (1), the amorphous sulfide solid electrolyte (1) and the crystalline sulfide solid electrolyte (1). The pattern of the electrolyte precursor (1) differs from that of the raw material inclusion, and it is confirmed that, by stirring, the raw material inclusion was consumed. In addition, it is confirmed that the electrolyte precursor (1) changed to the amorphous sulfide solid electrolyte (1) by heating, and further by heating, this was crystallized to be the thio-LISICON Region II-type crystal structure-containing crystalline sulfide solid electrolyte (1).

### Example 2 to Example 6

Amorphous sulfide solid electrolytes (2) to (6) and crystalline sulfide solid electrolytes (2) to (6) were produced in the same manner as in Example 1, except that, in an inert gas atmosphere in a glove box, the modified P₂S₅ described in Table 2 was used in the amount described in Table 2, and Li₂S was used in the amount described in Table 2. From the XRD patterns thereof, it is confirmed that the crystalline sulfide solid electrolytes (2) to (6) each contain a thio-LISICON Region II-type crystal structure.

TABLE 2

| | | Amount of modified | Amount of |
|---|---|---|---|
| | Modified P₂S₅ | P₂S₅ used (g) | Li₂S used (g) |
| Example 1 | Modified P₂S₅ (1) | 1.91 | 1.17 |
| Example 2 | Modified P₂S₅ (2) | 2.00 | 1.15 |
| Example 3 | Modified P₂S₅ (3) | 2.09 | 1.13 |
| Example 4 | Modified P₂S₅ (4) | 1.99 | 1.15 |
| Example 5 | Modified P₂S₅ (5) | 1.99 | 1.15 |
| Example 6 | Modified P₂S₅ (6) | 2.08 | 1.13 |

### Comparative Example 1

In an inert gas atmosphere in a glove box, 1.89 g of unmodified P₂S₅, 1.17 g of Li₂S, 0.369 g of LiBr and 0.569 g of LiI were weighed in a Schlenk bottle having a stirring bar therein, and 8.9 mL of a complexing agent N,N,N′,N′-tetramethylethylenediamine (TMEDA) and 40 mL of a solvent cyclohexane were put thereinto. This was stirred for 3 days at room temperature not heated from the outside. The stirring was stopped, this was depressurized for 2 hours with a vacuum pump to dry the liquid TMEDA and cyclohexane, thereby giving a powdery electrolyte precursor.

The resultant electrolyte precursor was heated at 110° C. for 2 hours to give an amorphous sulfide solid electrolyte.

Further the resultant amorphous sulfide solid electrolyte (C1) was heated at 180° C. for 2 hours to give a crystalline sulfide solid electrolyte (C1). From the XRD pattern thereof, it is confirmed that the crystalline sulfide solid electrolyte (C1) contains a thio-LISICON Region II-type crystal structure.

### Comparative Example 2

In an inert gas atmosphere in a glove box, 4.0 g of the crystalline sulfide solid electrolyte (C1) obtained in Comparative Example 1 was weighed in a Schlenk bottle having a stirring bar therein, and 50 mL of a solvent toluene was put thereinto. 250 mg of octanethiol was further put thereinto and stirred at room temperature for 12 hours. The stirring was stopped, this was depressurized for 2 hours with a vacuum pump to dry the liquid toluene and octanethiol, thereby giving a crystalline sulfide solid electrolyte (C2). From the XRD pattern thereof, it is confirmed that the crystalline sulfide solid electrolyte (C2) contains a thio-LISICON Region II-type crystal structure.

### Comparative Example 3

A crystalline sulfide solid electrolyte (C3) was produced in the same manner as in Comparative Example 1, except that 110 mg of dibutylamine was used in place of octanethiol. From the XRD pattern thereof, it is confirmed that the crystalline sulfide solid electrolyte (C3) contains a thio-LISICON Region II-type crystal structure.

The ratio of the content (mol) of sulfur atom, phosphorus atom and halogen atom per the content (mol) of lithium atom in each resultant sulfide solid electrolyte is described in Table 3, and for Examples 4 to 6, the content of nitrogen atom or oxygen atom per the content of lithium atom (item of nitrogen atom/oxygen atom in Table 3) is also described in Table 3.

The ionic conductivity and the H₂S generation amount are described in Table 4.

TABLE 3

| | | Nitrogen Atom/ | Phosphorus | Halogen |
|---|---|---|---|---|
| | Sulfur Atom | Oxygen Atom | Atom | Atom |
| Example 1 | 1.146 | — | 0.287 | 0.143 |
| Example 2 | 1.159 | — | 0.290 | 0.145 |
| Example 3 | 1.177 | — | 0.294 | 0.147 |
| Example 4 | 1.145 | 0.0145 | 0.290 | 0.145 |
| Example 5 | 1.145 | 0.0145 | 0.290 | 0.145 |
| Example 6 | 1.147 | 0.0295 | 0.294 | 0.147 |
| Comparative | 1.143 | — | 0.286 | 0.143 |
| Example 1 | | | | |

From the results of Examples 1 to 6, it is known that the sulfide solid electrolyte of the present embodiment is equivalent to the sulfide solid electrolyte of Comparative Example 1 in point of the ionic conductivity.

TABLE 4

| | | | Ionic | H₂S Generation |
|---|---|---|---|---|
| | Modifying | Modifying | Conductivity | Amount |
| | Agent | Agent/P | (mS/m) | (cc/g) |
| Example 1 | 1-octanethiol | 0.0100 | 4.0 | 1.51 |
| Example 2 | 1-octanethiol | 0.0500 | 3.8 | 0.70 |
| Example 3 | 1-octanethiol | 0.1020 | 3.9 | 0.28 |
| Example 4 | 1-octanol | 0.0500 | 2.6 | 0.80 |
| Example 5 | n-dibutylamine | 0.0500 | 3.9 | 0.27 |
| Example 6 | n-dibutylamine | 0.1000 | 3.3 | 0.00 |
| Comparative | — | — | 4.2 | 1.74 |
| Example 1 | | | | |
| Comparative | 1-octanethiol | 0.1000 | 3.0 | 1.80 |
| Example 2 | | | | |
| Comparative | n-dibutylamine | 0.0500 | 3.3 | 1.80 |
| Example 3 | | | | |

From FIG. 4, it is confirmed that the sulfide solid electrolyte (Examples 1 to 6) of the present embodiment has a greater effect of suppressing H₂S generation amount as compared with the sulfide solid electrolyte of Comparative Example 1 into which an organic compound group is not introduced.

In addition, as compared with the sulfide solid electrolyte (corresponding to Comparative Examples 2 and 3) where an organic compound group is introduced in the sulfide solid electrolyte like in PTL 1, the H₂S generation suppressing effect of the sulfide solid electrolyte of the present embodiment is great.

It is confirmed that the sulfide solid electrolytes of Examples 1 to 3 using a thiol compound as a modifier is excellent in suppressing ionic conductivity reduction, that the sulfide solid electrolyte of Example 4 using an alcohol compound as a modifier has a good balance between ionic conductivity reduction suppressing effect and waterproofness, and that the sulfide solid electrolytes of Examples 5 and 6 using a secondary amine compound as a modifier tend to be excellent in waterproofness.

Further, it is confirmed that an electrode mixture and a lithium ion battery produced using the crystalline sulfide solid electrolyte (1) have excellent battery characteristics.

### INDUSTRIAL APPLICABILITY

According to the production method for a sulfide solid electrolyte of the present embodiment, there can be readily produced a crystalline sulfide solid electrolyte having a high ionic conductivity and capable of suppressing hydrogen sulfide gas generation.

The crystalline sulfide solid electrolyte obtained by the production method of the present embodiment is suitably used for lithium ion batteries, especially lithium ion batteries to be used for information-related instruments and communication instruments such as personal computers, video cameras, and mobile phones.

1: A production method for a sulfide solid electrolyte, the method comprising:
mixing a raw material inclusion containing at least two raw materials, wherein:
the raw material contains at least one atom selected from the group consisting of a lithium atom, a sulfur atom, a phosphorus atom, and a halogen atom, and
the raw material inclusion contains modified P₂S₅.

2: The production method for a sulfide solid electrolyte according to claim 1, wherein the modified P₂S₅ is P₂S₅ provided with an organic group.

3: The production method for a sulfide solid electrolyte according to claim 2, wherein the organic group contains a hetero atom.

4: The production method for a sulfide solid electrolyte according to claim 3, wherein the modified P₂S₅ contains a covalent bond between the phosphorus atom of P₂S₅ in the modified P₂S₅ and the hetero atom.

5: The production method for a sulfide solid electrolyte according to claim 3, wherein the hetero atom is at least one selected from the group consisting of a sulfur atom, an oxygen atom, and a nitrogen atom.

6: The production method for a sulfide solid electrolyte according to claim 2, wherein the organic group is at least one selected from the group consisting of a group represented by formula (a-1), a group represented by formula (a-2), and a group represented by and formula (b-1): 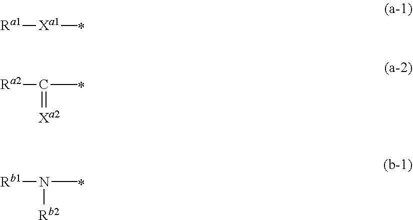
wherein * indicates a bonding site to P₂S₅; R^{a1}, R^{a2}, R^{b1} and R^{b2} each independently represent a monovalent organic group; and X^{a1} and X^{a2} each independently represent an oxygen atom or a sulfur atom.

7: The production method for a sulfide solid electrolyte according to claim 1, wherein a stirring machine, a mixing machine or a grinding machine is used in the mixing.

8: The production method for a sulfide solid electrolyte according to claim 1, wherein the raw material inclusion and a complexing agent are mixed in the mixing.

9: The production method for a sulfide solid electrolyte according to claim 1, wherein the mixing is performed in a solvent.

10: The production method for a sulfide solid electrolyte according to claim 1, further comprising heating.

11: The production method for a sulfide solid electrolyte according to claim 1, wherein the sulfide solid electrolyte contains a thio-LISICON Region II-type crystal structure.

12: A sulfide solid electrolyte, comprising: a lithium atom, a sulfur atom, a phosphorus atom, a halogen atom, and an organic group, wherein:
a ratio of a molar content of the sulfur atom, the phosphorus atom, and the halogen atom per molar content of the lithium atom is represented by lithium atom/sulfur atom/phosphorus atom/halogen atom, which is 1/1.1000 to 1.2000/0.2000 to 0.3500/0.1400 to 0.1550.

13: An electrode mixture, comprising: the sulfide solid electrolyte according to claim 12, and an electrode active material.

14: A lithium ion battery, comprising: at least one of
the sulfide solid electrolyte according to claim 12 and
an electrode mixture containing the sulfide solid electrolyte and an electrode active material.

15: A modified P₂S₅ for production of a sulfide solid electrolyte provided with an organic group.
